(19) United States
(12) Patent Application Publication
(10) Pub. No.: US 2026/0080798 A1
(43) Pub. Date: Mar. 19, 2026

(54) DYNAMIC CONTENT MODIFICATION BASED ON USER INPUT

(71) Applicant: APPLE INC., Cupertino, CA (US)

(72) Inventors: Barry-John Theobald, Cupertino, CA (US); Nicholas E. Apostoloff, Cupertino, CA (US); Russell Y. Webb, Cupertino, CA (US)

(21) Appl. No.: 19/328,879

(22) Filed: Sep. 15, 2025

Related U.S. Application Data
(60) Provisional application No. 63/695,317, filed on Sep. 16, 2024.

(51) Int. Cl. G09B 7/08; G06F 40/30; G06T 13/80; G06V 40/18; G09B 19/04

(52) U.S. Cl. CPC G09B 7/08; G06F 40/30; G06T 13/80; G06V 40/18; G09B 19/04

(57) ABSTRACT

A method includes displaying, on a display, text that corresponds to a portion of a media content item. The method includes, after displaying the text on the display, displaying, on the display, a question that relates to the text in order to determine whether a user of the device is comprehending the text. The method includes receiving a user input in response to displaying the question. The method includes modifying content of the media content item based on an evaluation of the user input.

### CROSS-REFERENCES TO RELATED APPLICATIONS

This application claims priority to U.S. Provisional Patent App. No. 63/695,317, filed on Sep. 16, 2024, which is hereby incorporated by reference in its entirety.

### TECHNICAL FIELD

The present disclosure generally relates to dynamic content modification based on user input.

### BACKGROUND

Some devices include a display for presenting content. For example, some devices present electronic books, stories, articles, etc. While some users may be able to read text, they may not be able to comprehend the text. As such, some users may not comprehend the content that the device presents thereby detracting from a user experience provided by the device and resulting in unnecessary resource consumption associated with presenting the content.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1AA are diagrams of an example environment in accordance with some implementations.

FIG. 2 is a block diagram of a system that dynamically modifies content in accordance with some implementations.

FIG. 3 is a flowchart representation of a method of dynamically modifying content in accordance with some implementations.

FIG. 4 is a block diagram of a device that dynamically modifies content in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for dynamically modifying content based on user input. In some implementations, a device includes a display, non-transitory memory and one or more processors. In various implementations, a method includes displaying, on the display, text that corresponds to a portion of a media content item. In some implementations, the method includes, after displaying the text on the display, displaying, on the display, a question that relates to the text in order to determine whether a user of the device is comprehending the text. In some implementations, the method includes receiving a user input in response to displaying the question. In some implementations, the method includes modifying content of the media content item based on an evaluation of the user input.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Some devices include a display for presenting content. For example, some devices present textual content such as e-books, stories, articles, etc. While some users may be able to read text, they may not be able to comprehend the text. As such, some users may not comprehend the content that the device presents thereby detracting from a user experience provided by the device. When the device presents content that the user is unable to comprehend, the device unnecessarily utilizes resources associated with presenting the content. For example, the display of the device unnecessarily consumes power while displaying content that the user is unable to comprehend. Furthermore, presenting content that the user is unable to comprehend can be more resource intensive than presenting content that the user is able to comprehend because the user may gaze at incomprehensible content for a longer time duration thereby keeping the display on for a longer time duration and unnecessarily consuming additional power.

The present disclosure provides methods, systems, and/or devices for dynamically modifying content of a media content item in order to assist a user in comprehending the content. device presents text for the user to read. The user may read the text out loud or quietly. The device generates a set of one or more questions to test the user's comprehension. The device modifies the content based on the user's response to the question(s). For example, if the user answers the questions correctly, the device animates an object depicted in an image (e.g., if the book depicts a treasure box, the device displays an animation of the treasure box opening when the user answers the questions correctly).

The device can vary a complexity of the text based on the user's response. For example, if the user answers the question(s) incorrectly, the device can simplify the story in order to increase a likelihood of the user comprehending the story (e.g., by using shorter sentences, reducing a number of characters, simplifying relationships between the characters, etc.). By contrast, if the user answers the questions(s) correctly, the device increases a complexity of the story in order to challenge the user (e.g., by using more complex sentences, introducing more characters, introducing more relationships between the characters).

In various implementations, modifying the content based on the user's response enhances a user experience provided by the device by keeping the user more engaged. In various implementations, modifying the content based on the user's reading comprehension level improves a functionality of the device. Presenting content that the user comprehends tends to reduce an amount of time that the user requires to read the content thereby reducing an amount of time that the display is kept on for. Reducing an amount of time that the display is kept on for reduces a power consumption of the device and extends a battery life of the device. Reducing power consumption and extending the battery life of the device improves a functionality of the device.

Modifying content based on the user's comprehension of the content tends to reduce user inputs associated with performing searches in order to understand the content. Reducing user inputs associated with content that the user is unable to comprehend improves a functionality of the device by reducing resource consumption associated with analyzing the user inputs. For example, reducing the need to perform searches to understand incomprehensible content reduces a number of data transmissions between the device and a wireless access point thereby reducing bandwidth consumed by the device, reducing a power consumption of the device and extending a battery life of the device.

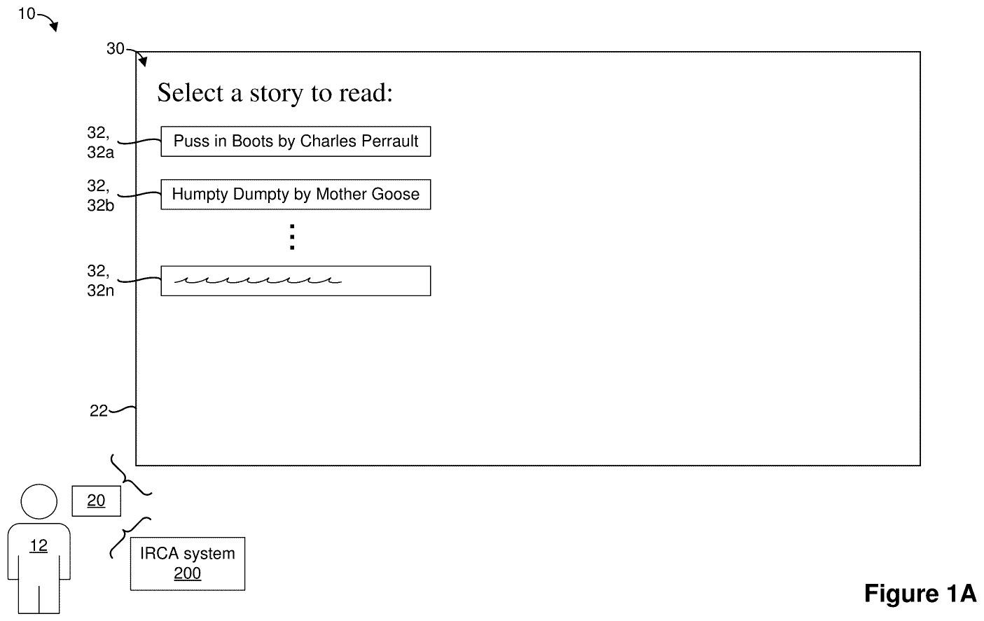

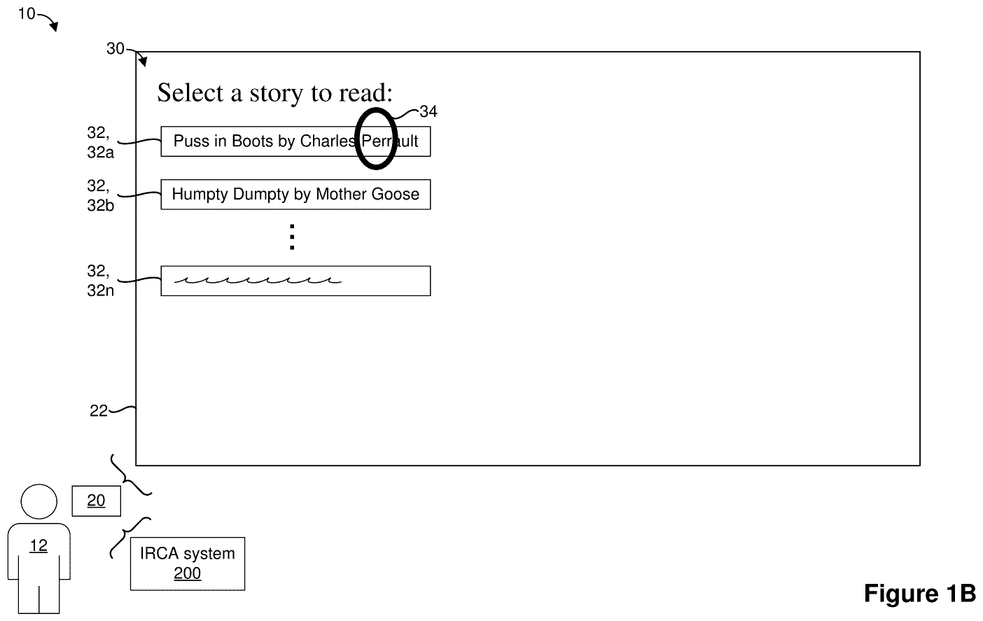

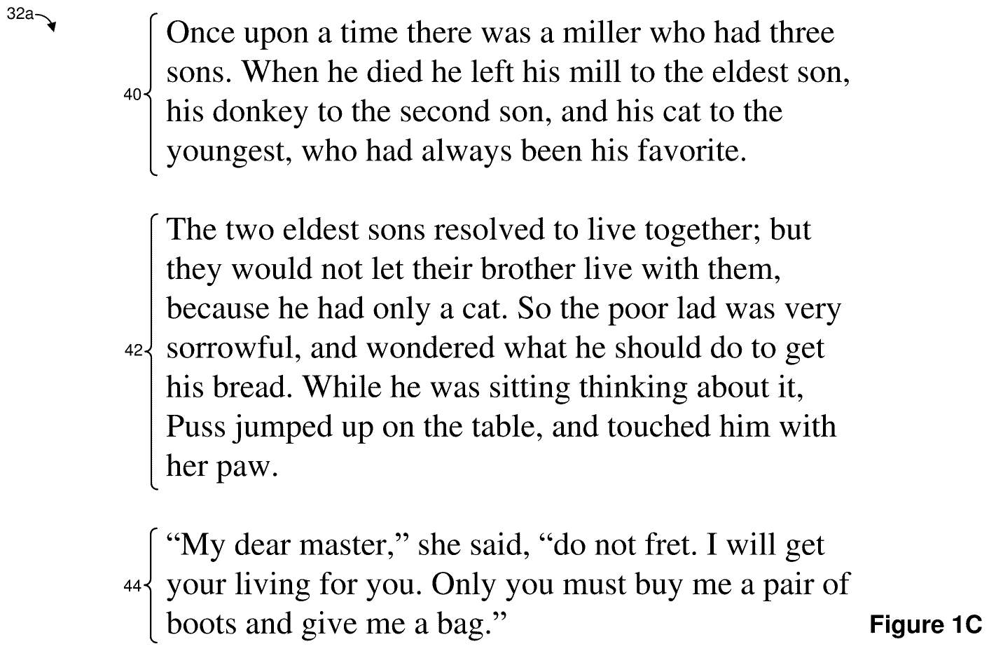

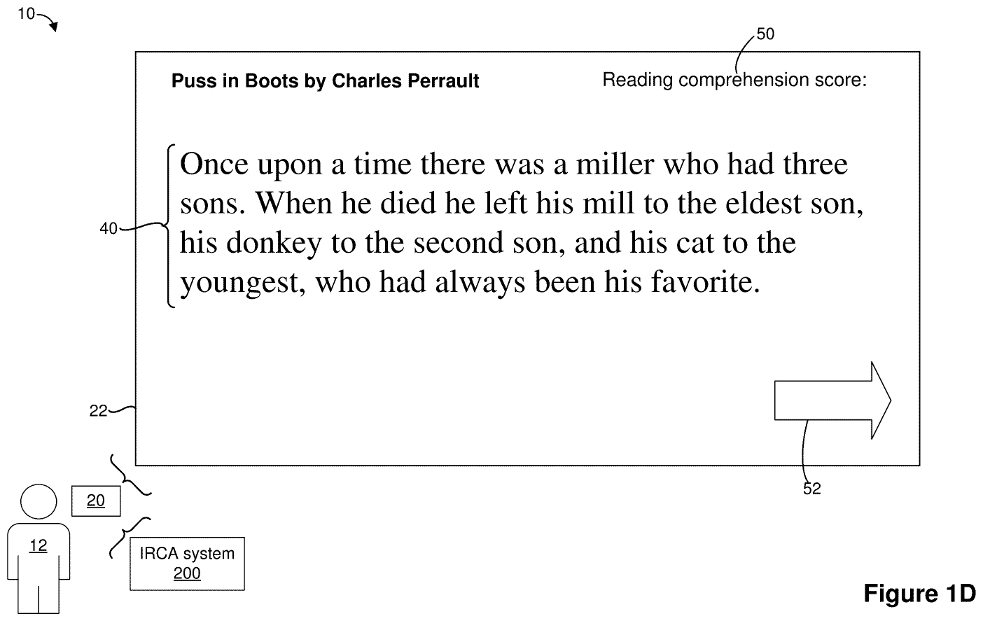

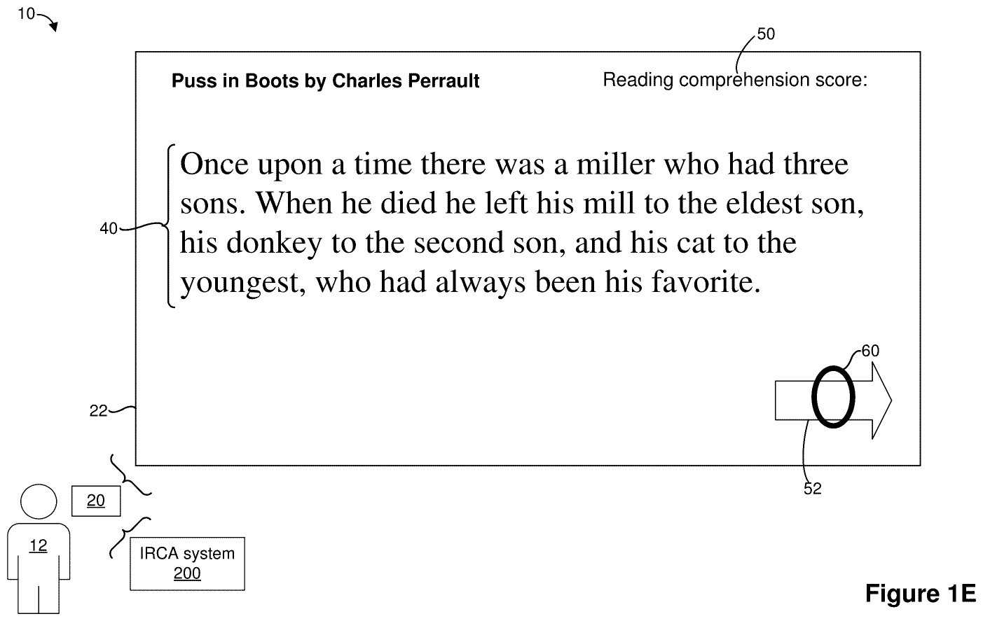

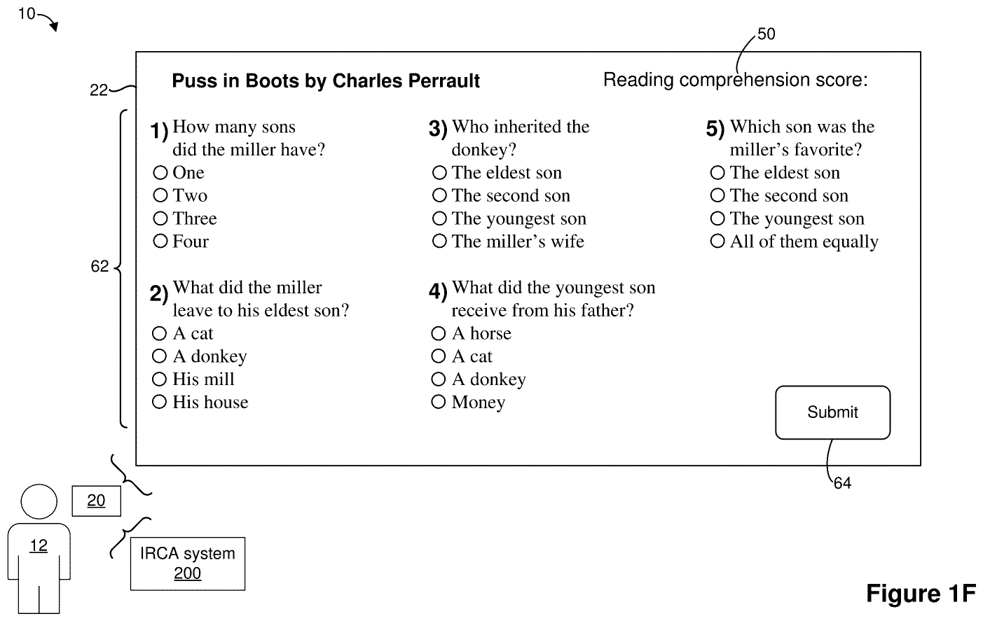

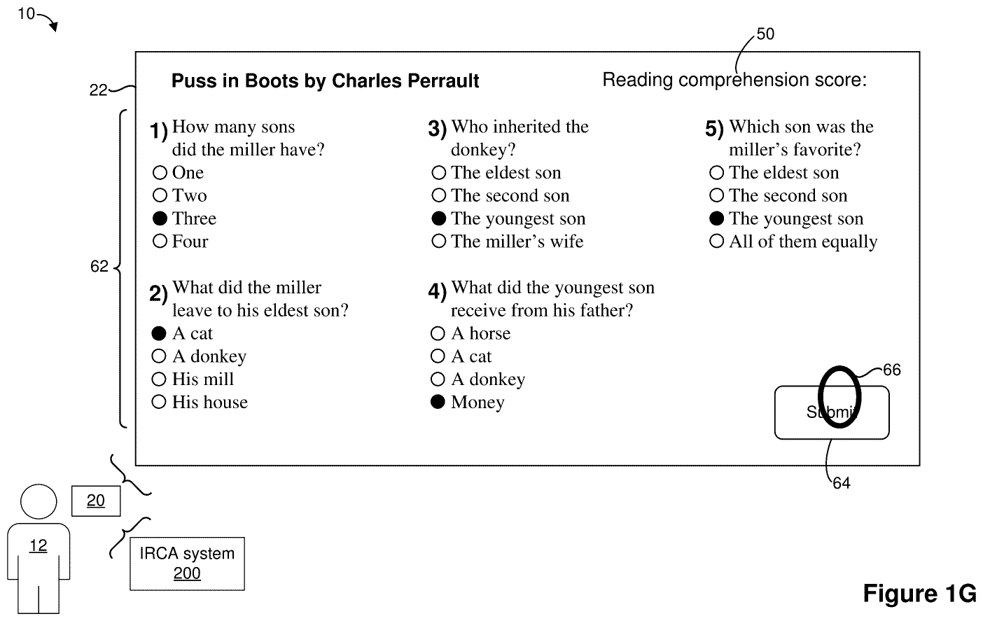

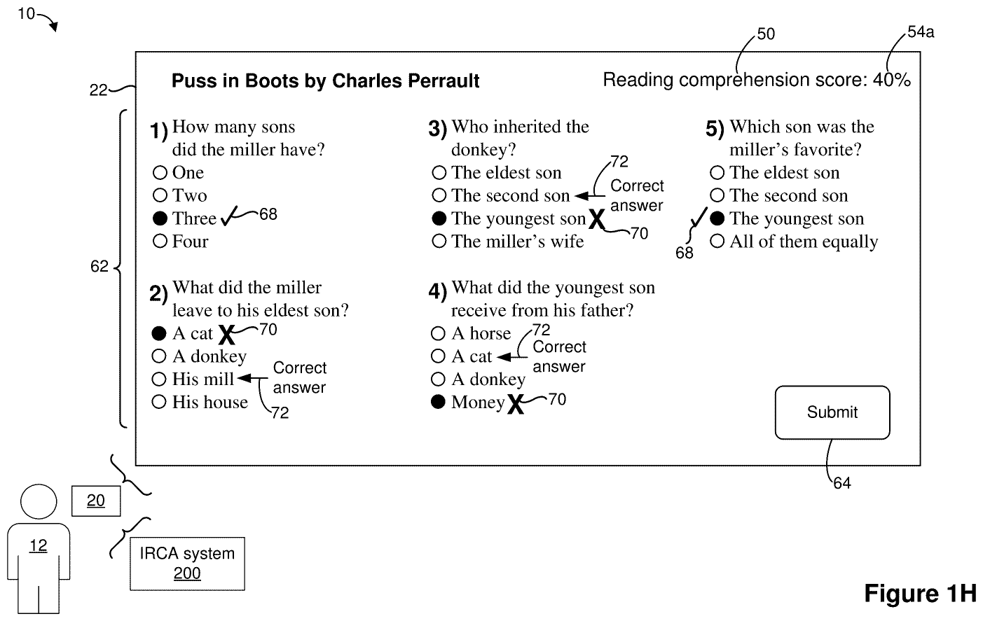

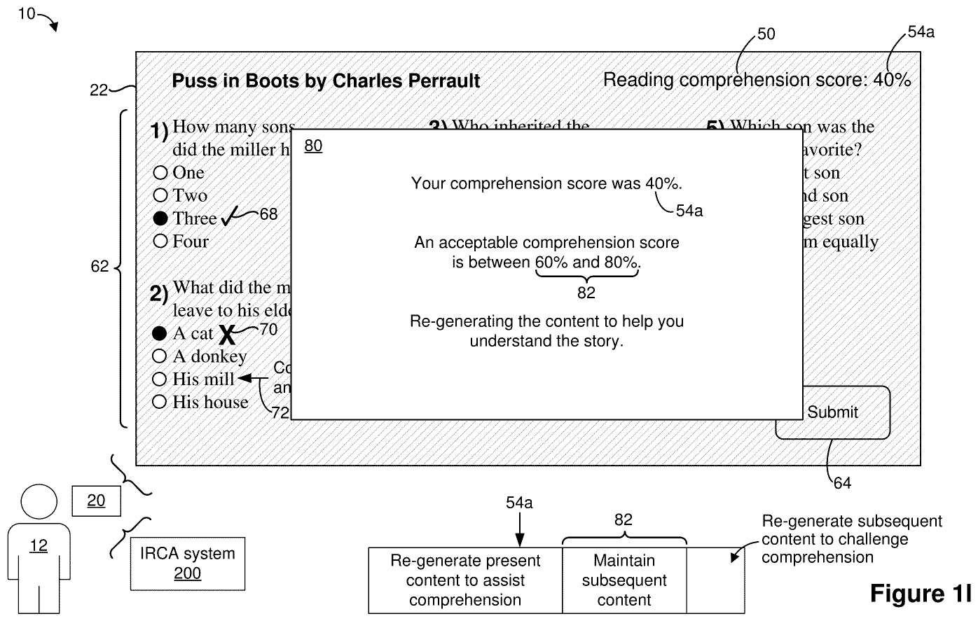

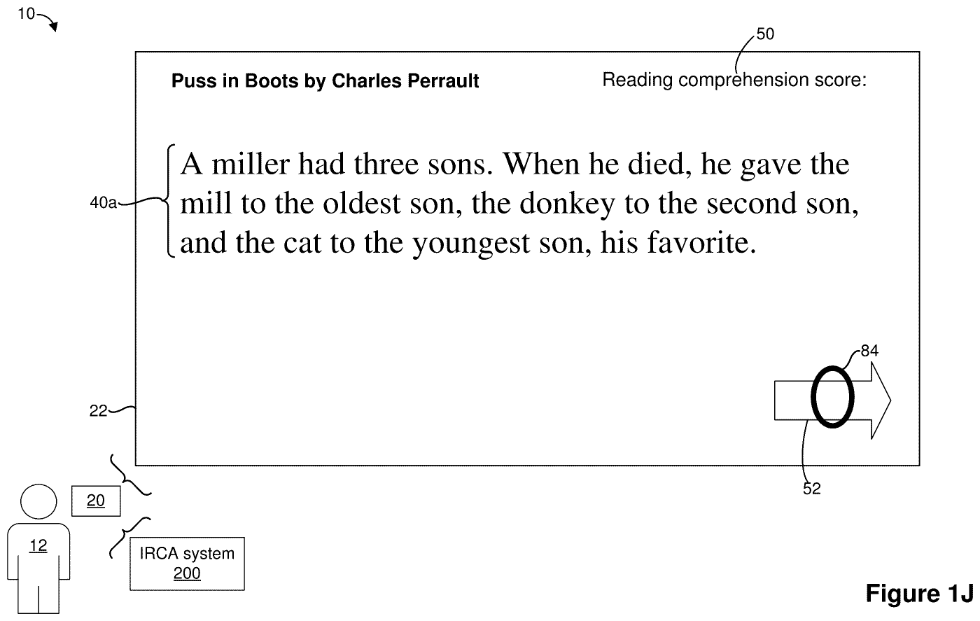

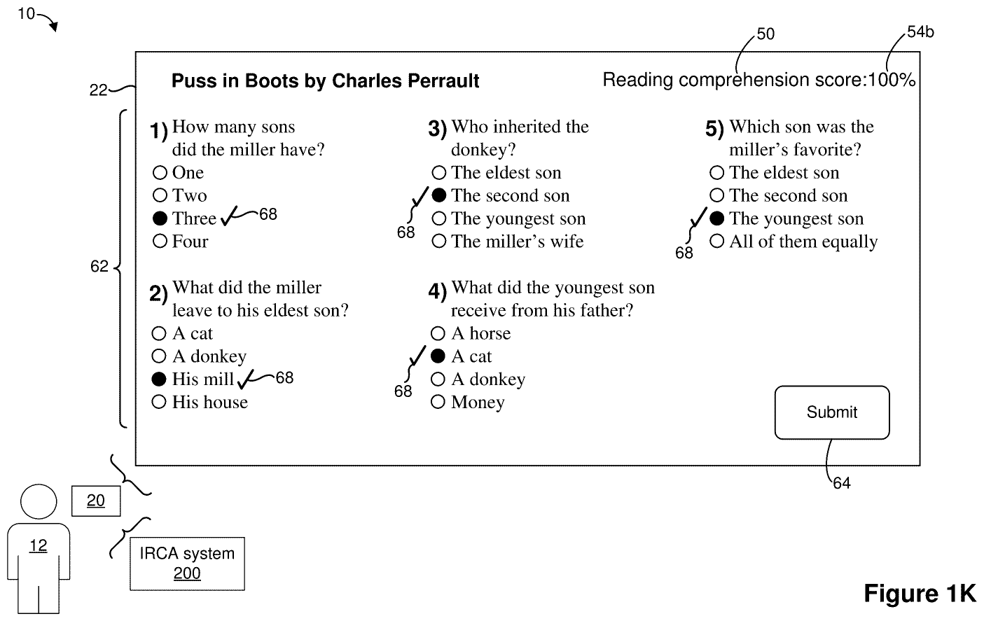

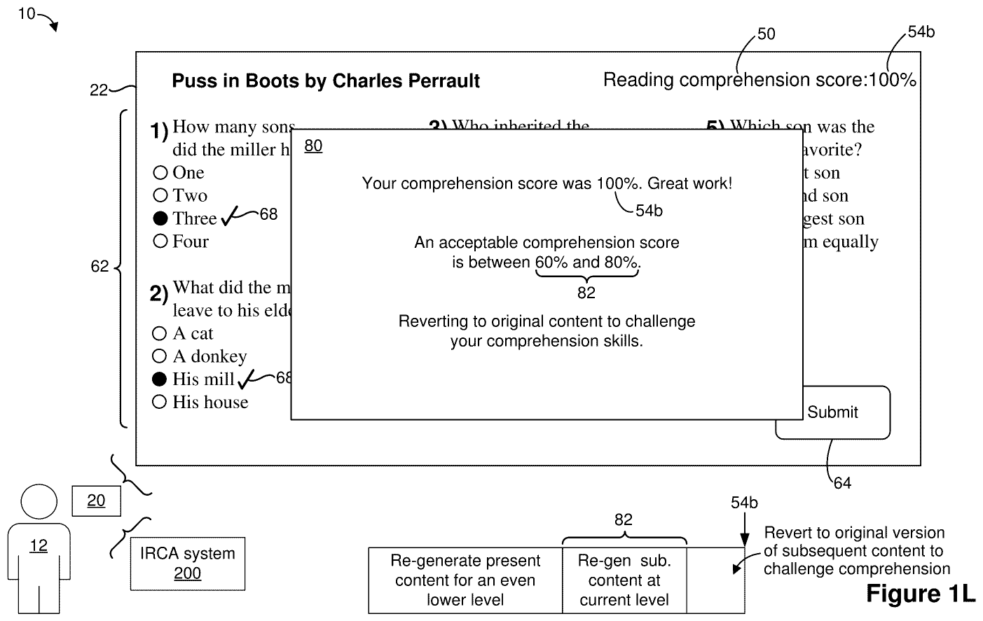

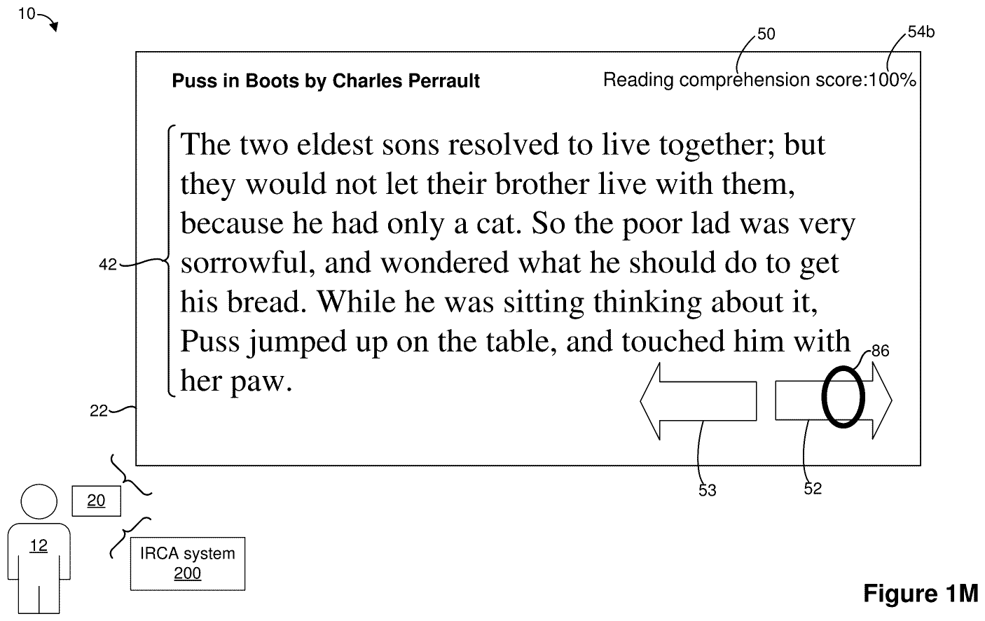

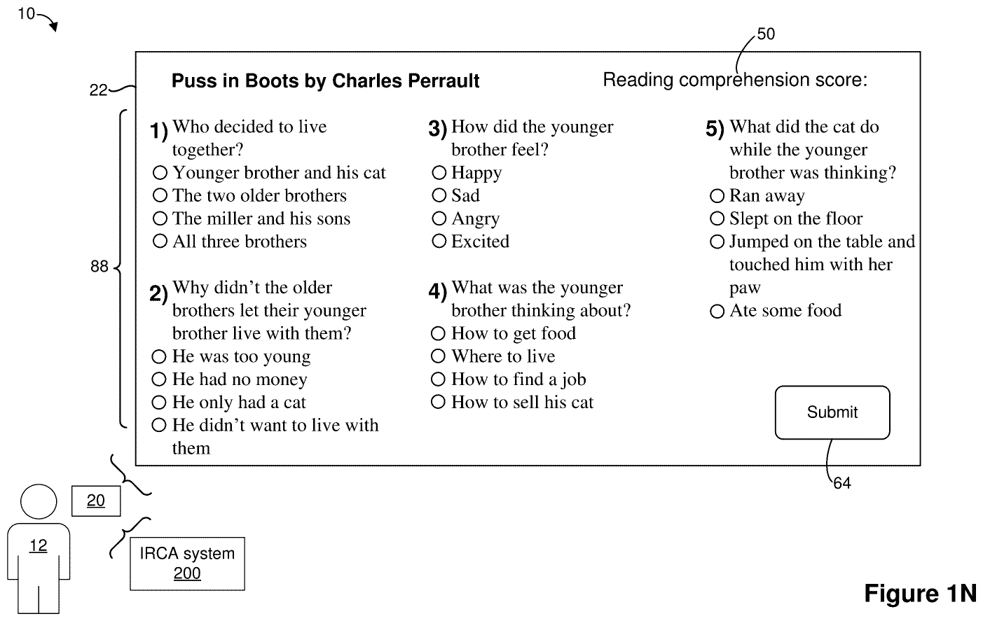

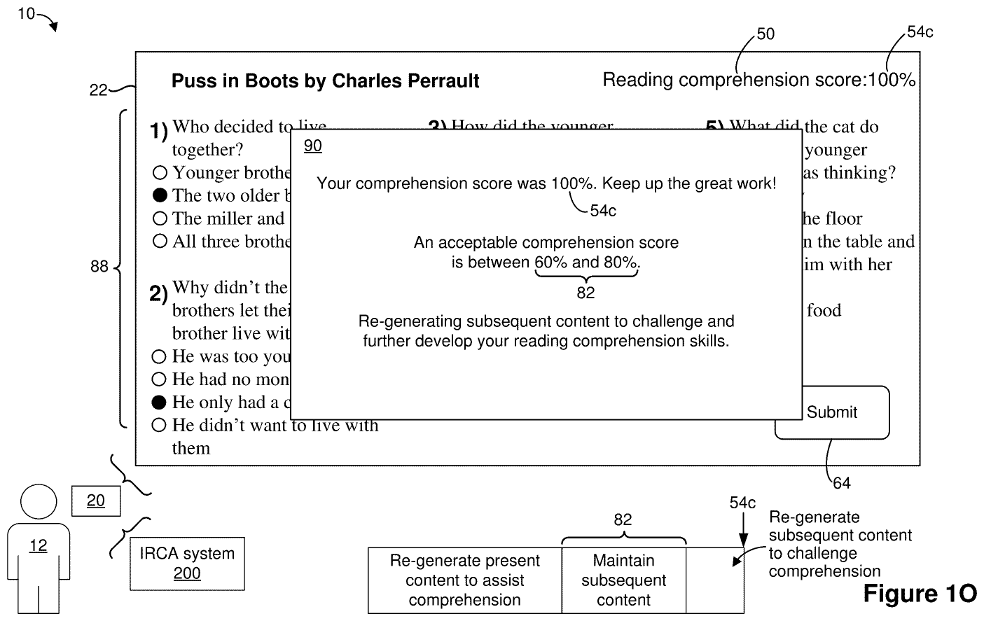

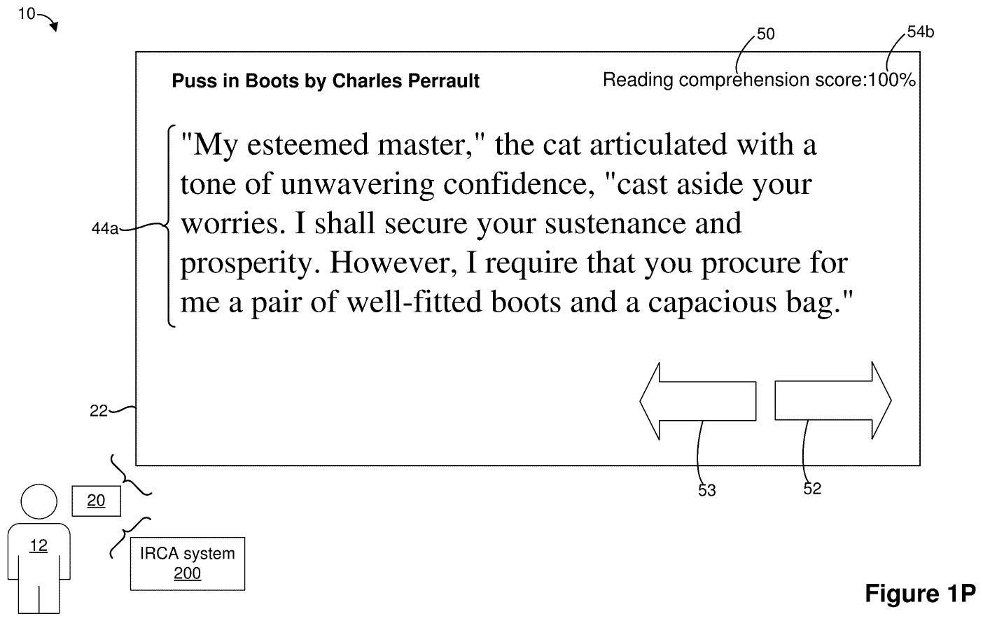

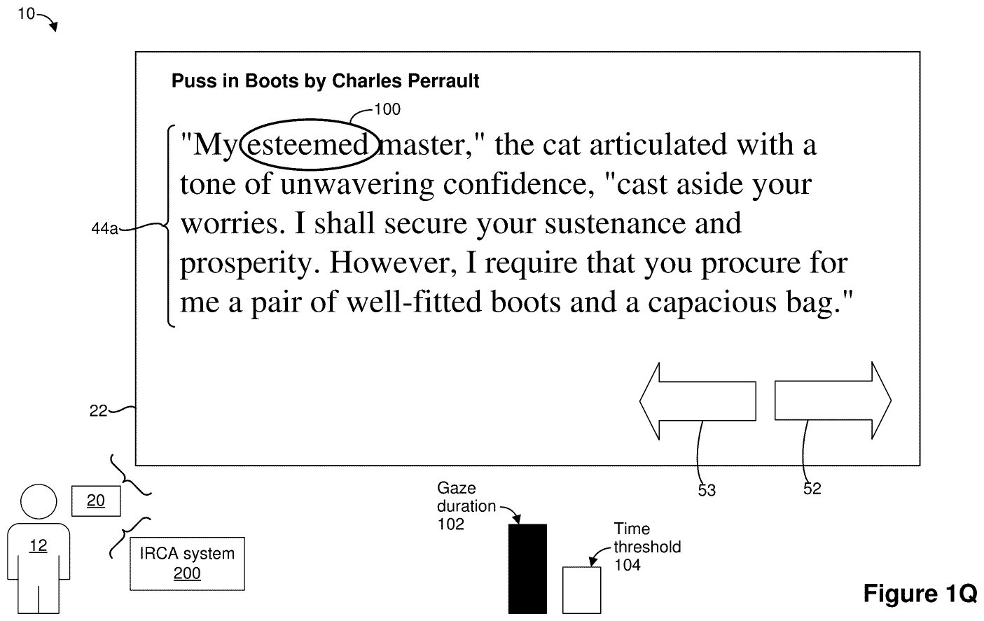

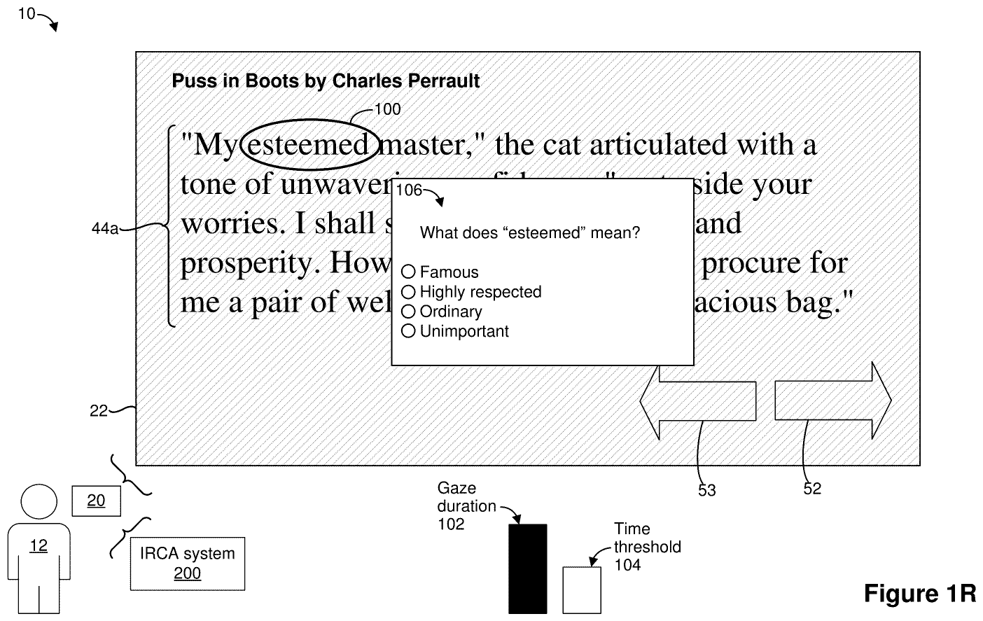

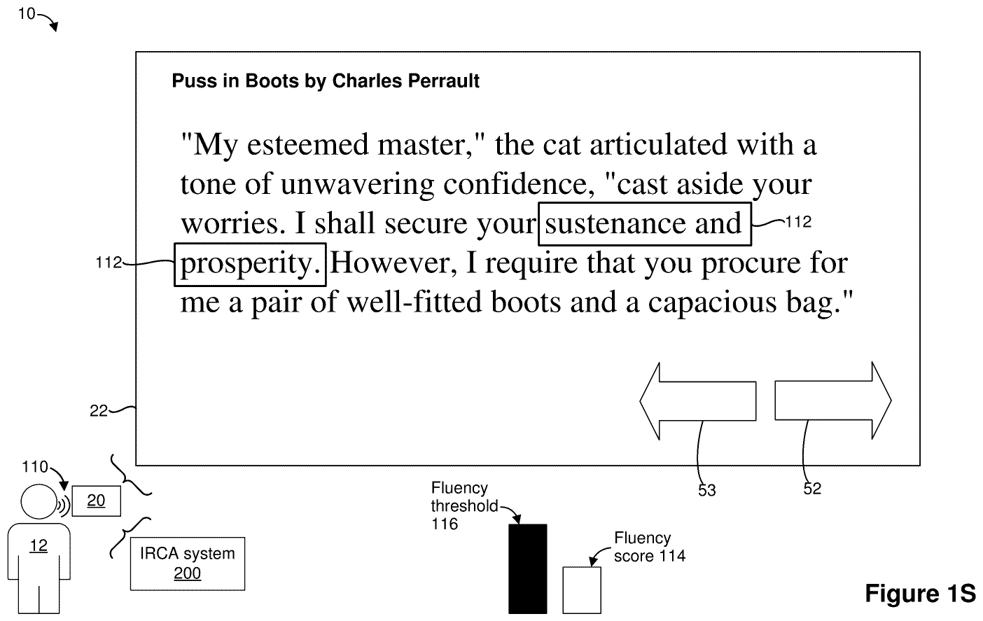

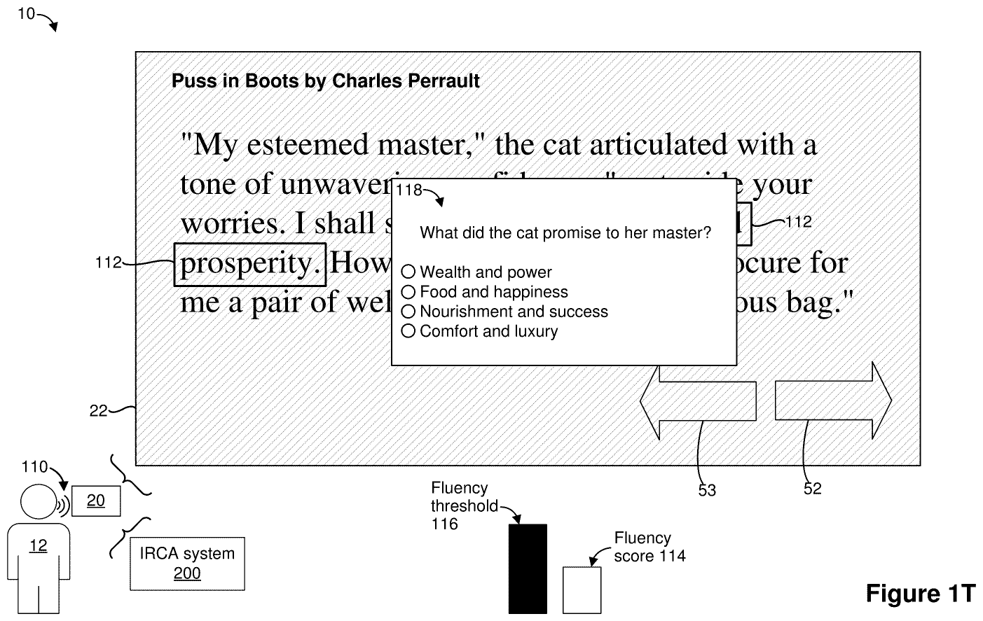

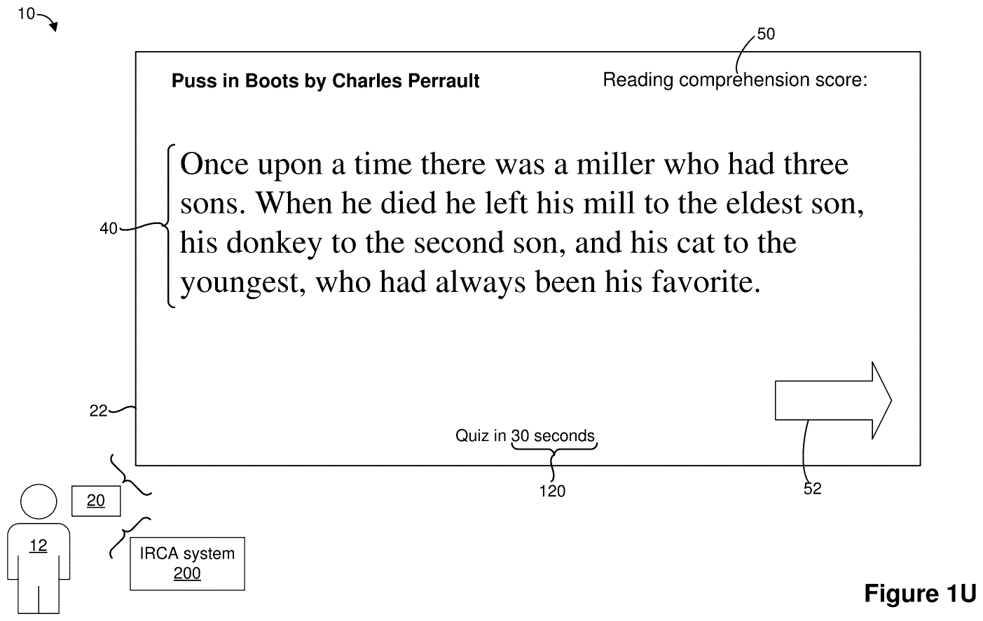

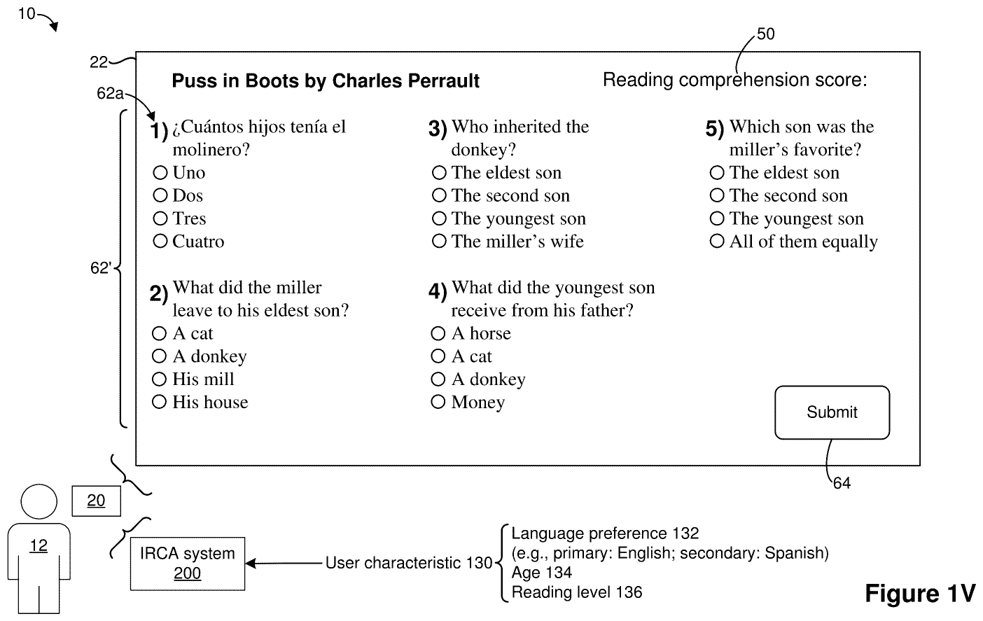

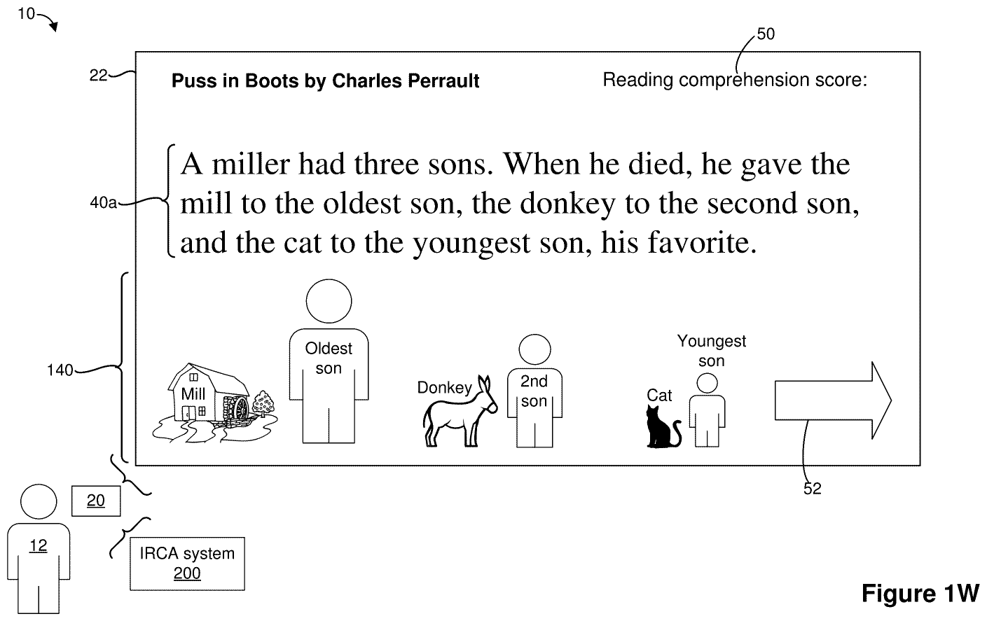

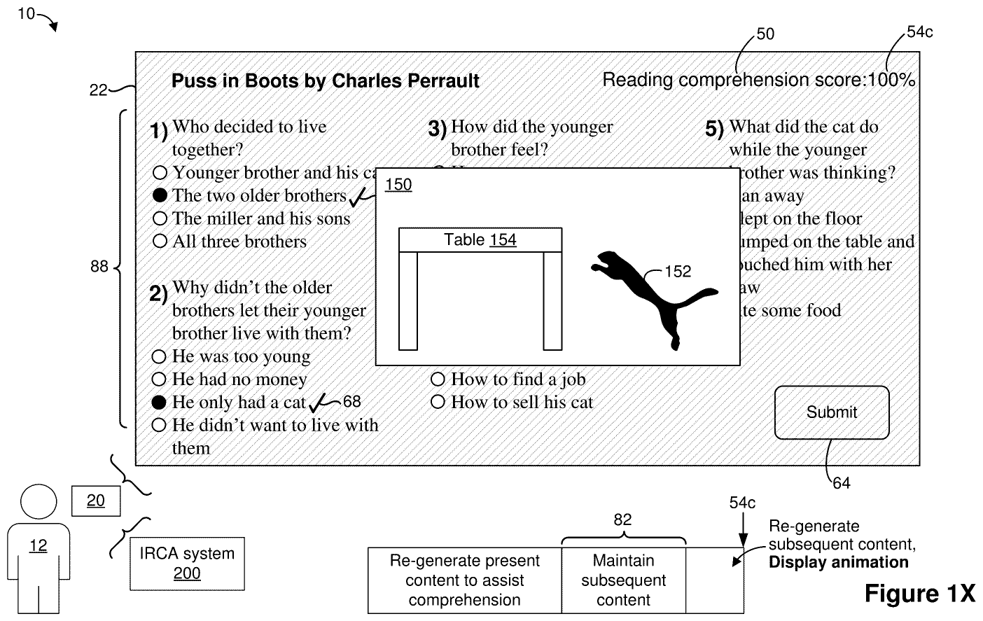

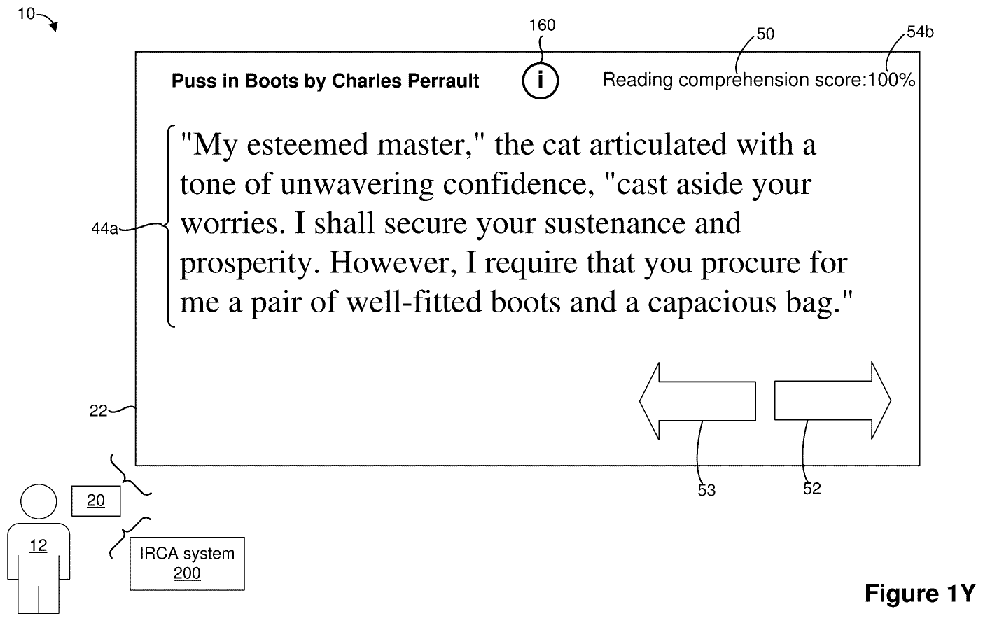

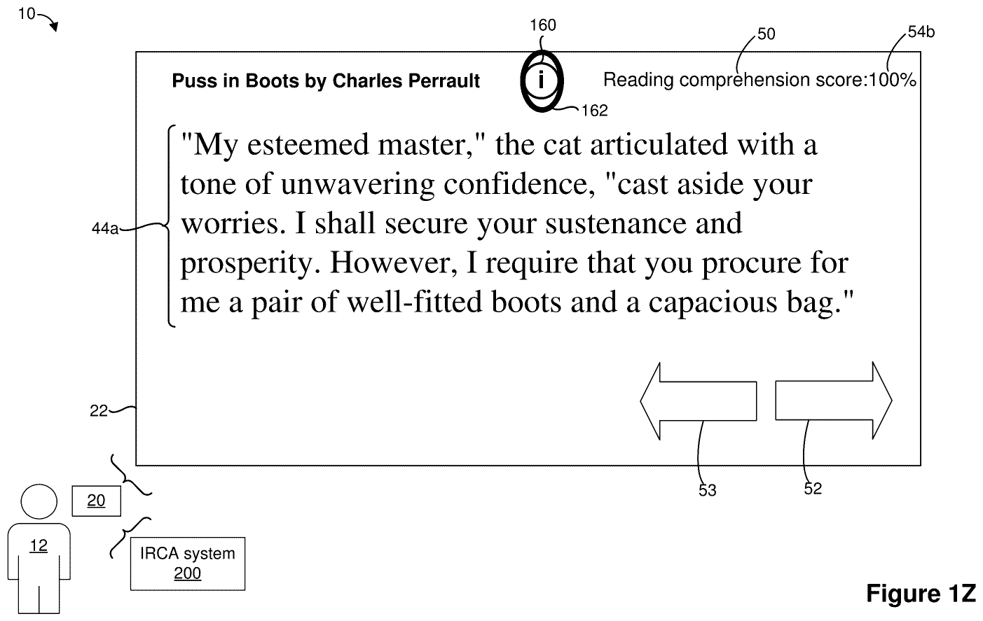

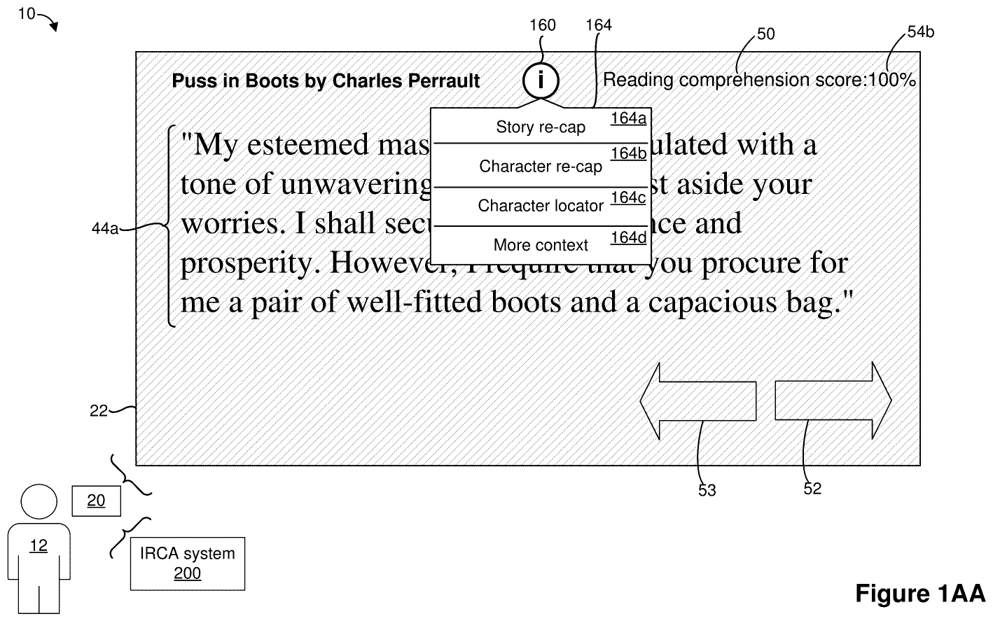

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12 and an electronic device 20 (“device 20”, hereinafter for the sake of brevity). In some implementations, the device 20 includes an interactive reading comprehension assistant (IRCA) system (“system 200”, hereinafter for the sake of brevity) that modifies content based on a reading comprehension of the user 12.

In some implementations, the device 20 includes a handheld computing device that can be held by the user 12. For example, in some implementations, the device 20 includes a smartphone, a tablet, a media player, a laptop, or the like. In some implementations, the device 20 includes a wearable computing device that can be worn by the user 12. For example, in some implementations, the device 20 includes a head-mountable device (HMD) or an electronic watch.

In various implementations, the device 20 includes a display 22 for presenting content. In the example of FIG. 1A, the display 22 displays a graphical user interface (GUI) 30 for reading (“reading interface 30”, hereinafter for the sake of brevity). The reading interface 30 displays representations of various media content items 32 (e.g., a first media content item 32a, a second media content item 32b, . . . , and an nth media content item 32n). The user 12 can select one of the representations of the media content items 32 in order to view the corresponding media content item. In various implementations, the media content items 32 include textual content. In some implementations, the media content items 32 are electronic books (e-books), electronic magazines, electronic newspapers, stories, articles, etc. In some implementations, the media content items 32 include graphical content in addition to textual content. In some implementations, the media content items 32 include images and/or videos. In the example of FIG. 1A, the first media content item 32a represents a first story (Puss in Boots by Charles Perrault) and the second media content item 32b represents a second story (Humpty Dumpty by Mother Goose).

Referring to FIG. 1B, the device 20 detects a user input 34 selecting the representation for the first media content item 32a. For example, the device 20 detects a tap gesture (e.g., a contact) at a display location corresponding to the first media content item 32a. The user input 34 corresponds to a request to view the first media content item 32a. While FIG. 1B illustrates the user input 34 as a tap gesture, in some implementations, the user input 34 selecting the first media content item 32a includes a voice input or a gaze input.

FIG. 1C depicts content of the first media content item 32a. The first media content item 32a includes various portions (e.g., sentences, paragraphs, pages, sections, chapters or screens). In the example of FIG. 1C, the first media content item 32a includes a first portion 40 (e.g., a first paragraph), a second portion 42 (e.g., a second paragraph) and a third portion 44 (e.g., a third paragraph). In various implementations, the first media content item 32a includes other portions (e.g., additional paragraphs) that are not shown in FIG. 1C. In various implementations, the content depicted in FIG. 1C is referred to as human-curated content, for example, because the content is written by a human (e.g., an author). In some implementations, the content depicted in FIG. 1C is referred to as author-generated content, for example, because the content is generated by an author.

Referring to FIG. 1D, in response to detecting the user input 34 shown in FIG. 1B, the device 20 presents the first portion 40 of the first media content item 32a on the display 22. In some implementations, the device 20 presents additional GUI elements within the reading interface 30. In the example of FIG. 1D, the device 20 displays a reading comprehension score 50 that indicates how well the user 12 understands the content of the first media content item 32a. As the user 12 reads a particular portion of the first media content item 32a, the system 200 generates questions related to that particular portion and determines the reading comprehension score 50 based on user responses to the questions. In the example of FIG. 1D, the device 20 does not display a value adjacent to the reading comprehension score 50 because the user 12 has just begun reading the first portion 40 of the first media content item 32a. FIG. 1D further includes a next button 52 for navigating to a subsequent portion of the first media content item 32a.

In FIG. 1E, the device 20 detects a user input 60 selecting the next button 52. A user selection of the next button 52 indicates that the user 12 may have finished reading the first portion 40 of the first media content item 32a.

Referring to FIG. 1F, the device 20 presents a set of questions 62 in response to detecting the user input 60 shown in FIG. 1E. The questions 62 relate to the first portion 40 of the first media content item 32a. The questions 62 test a reading comprehension level of the user 12 with respect to the first portion 40 of the first media content item 32a. In the example of FIG. 1F, the questions 62 are multiple choice questions. Alternatively, in some implementations, the questions include open-ended questions that prompt the user 12 to provide a textual response. In the example of FIG. 1F, each question has four potential answers that are displayed adjacent to corresponding radio buttons. The user 12 can select an answer for each question by selecting a corresponding radio button. Once the user 12 has answered all the questions 62, the user 12 can select a submit button 64.

In some implementations, the system 200 utilizes a model (e.g., a generative model such as a Large Language Model (LLM)) to generate the questions 62. In such implementations, the questions 62 may be referred to as machine-generated questions. The model accepts the first portion 40 of the first media content item 32a as an input, and outputs the questions 62. The model may accept additional parameters such as a number of questions to generate, a number of answer choices to present for each question, an age of the user 12, a previous reading comprehension score of the user 12, etc.

In some implementations, the system 200 selects the questions 62 from a datastore that stores pre-generated questions and answers. In some implementations, the questions 62 are a subset of author-generated questions. For example, the author of the first media content item 32a provides a set of questions for the first media content item 32a, and the system 200 selects a subset of the questions that are related to the first portion 40 of the first media content item 32a.

Referring to FIG. 1G, the user 12 answers the questions 62 by selecting one of the radio buttons under each of the questions 62. The device 20 detects a user input 66 directed to the submit button 64.

Referring to FIG. 1H, the system 200 evaluates user responses to the questions 62 and generates a first reading comprehension value 54a to indicate how well the user 12 understood the first portion 40 of the first media content item 32a. In the example of FIG. 1H, the first reading comprehension value 54a is 40% indicating that the user 12 answered 40% of the questions 62 correctly and the remaining 60% of the questions 62 incorrectly. In the example of FIG. 1H, the device 20 displays a checkmark 68 adjacent to each question 62 that the user 12 answered correctly, a cross 70 adjacent to each question 62 that the user 12 answered incorrectly and an arrow 72 pointing to the correct answers for questions 62 that the user 12 answered incorrectly.

Turning to FIG. 1I, in some implementations, the device 20 displays a notification 80 that indicates the first reading comprehension value 54a. In the example of FIG. 1I, the notification 80 indicates an acceptable reading comprehension score range 82 (e.g., between 60% and 80%, greater than 60%, etc.). The notification 80 states that the device 20 is going to re-generate the content in order to help the user 12 better understand the content. In some implementations, the system 200 utilizes a generative model (e.g., an LLM) to re-generate content that the user 12 did not appear to understand. In some implementations, the system 200 re-generates the content when the reading comprehension score 50 is below the acceptable reading comprehension score range 82. In the example of FIG. 1I, the first reading comprehension value 54a is below a lower end of the acceptable reading comprehension score range 82. As such, the system 200 determines to re-generate the first portion 40 of the first media content item 32a in order to assist the user 12 in comprehending the first portion 40.

In various implementations, the system 200 determines to re-generate present content at a lower comprehension level when the reading comprehension score for the present content is below a threshold (e.g., below the lower end of the acceptable reading comprehension range 82). In some implementations, the system 200 determines to maintain a comprehension level of subsequent content at the same comprehension level as the present content when the reading comprehension score 50 is within the acceptable reading comprehension range 82. For example, if the reading comprehension score is within the acceptable reading comprehension range 82, the system 200 presents the second portion 42 of the first media content item 32a shown in FIG. 1C without re-generating the second portion 42 at a lower comprehension level.

In some implementations, the system 200 determines to re-generate subsequent content at a higher comprehension level in order to challenge the user 12 when the reading comprehension score 50 is greater than a threshold (e.g., greater than an upper end of the acceptable reading comprehension range 82, for example, greater than 80%). For example, the system 200 re-generates the second portion 42 of the first media content item 32a at a higher comprehension level in order to make the second portion 42 more difficult to comprehend and assist the user 12 in increasing his/her reading comprehension ability.

FIG. 1J presents a simplified version 40a of the first portion 40. The system 200 utilizes a generative model to generate the simplified version 40a. The generative model accepts the first portion 40 as an input and outputs the simplified version 40a. The generative model may accept additional inputs such as the first reading comprehension score value 54a, for example, so that the simplified version 40a is more suitable for the user 12.

In various implementations, the simplified version 40a has a lower lexical complexity than the first portion 40. In some implementations, the system 200 generates the simplified version 40a by shortening the first portion 40. In some implementations, the simplified version 40a utilizes shorter sentences than the first portion 40. In some implementations, the simplified version 40a replaces relatively long words with relatively short words in order to make the simplified version 40a more suitable for the user 12. In some implementations, the simplified version 40a represents a summary of the first portion 40.

In some implementations, the system 200 utilizes the user responses to the questions 62 shown in FIG. 1H in order to generate the simplified version 40a of the first portion 40. For example, the user 12 may have answered questions relating to a particular subset of the first portion 40 incorrectly while correctly answering questions related to a remainder of the first portion 40. In this example, the system 200 regenerates the particular subset of the first portion 40 while maintaining the remainder of the first portion 40. Alternatively, the system 200 simplifies the particular subset to a greater degree than the remainder of the first portion 40.

The device 20 detects a user input 84 directed to the next button 52. In response to detecting the user input 84, the device 20 re-presents the questions 62 as shown in FIG. 1K. In the example of FIG. 1K, the user 12 correctly answers the questions 62. As such, in FIG. 1K, the system 200 determines a second reading comprehension value 54b for the reading comprehension score 50.

Referring to FIG. 1L, the device 20 updates the notification 80 to indicate the second reading comprehension value 54b. In the example of FIG. 1L, since the second reading comprehension value 54b is greater than the upper end of acceptable reading comprehension range 82, the system 200 determines that the user 12 may be ready to comprehend content with a greater comprehension level. As such, the system 200 determines to revert to presenting an original version of the next portion of the first media content item 32a. For example, the system 200 determines to present the second portion 42 of the first media content item 32a shown in FIG. 1C instead of generating a simplified version of the second portion 42.

In FIG. 1M, the device 20 presents the second portion 42 of the first media content item 32a. In addition to displaying the next button 52, the device 20 displays a back button 53 to navigate back to the first portion 40 or the simplified version 40a of the first portion 40. After presenting the second portion 42 for an amount of time, the device 20 detects a user input 86 directed to the next button 52.

In response to detecting the user input 86 selecting the next button 52, the device 20 presents questions 88 related to the second portion 42 as shown in FIG. 1N. In some implementations, the system 200 utilizes the generative model to generate the questions 88. Alternatively, in some implementations, the system 200 selects the questions 88 from a set of pre-generated questions for the first media content item 32a.

Referring to FIG. 1O, the user 12 correctly answers all the questions 88. Since the user 12 correctly answered all the questions 88, the device 20 displays a third reading comprehension value 54c of 100%. The device 20 displays a notification 90 that indicates the third reading comprehension value 54c. The notification 90 further indicates that the third reading comprehension value 54c is above the upper end of the acceptable reading comprehension range 82. In various implementations, when the reading comprehension score 50 is above a threshold (e.g., above the upper end of the acceptable reading comprehension range 82), the system 200 determines to re-generate subsequent content in order to challenge the user 12.

Referring to FIG. 1P, the system 200 generates a complex version 44a of the third portion 44 of the first media content item 34a shown in FIG. 1C. The complex version 44a of the third portion 44 requires greater comprehension ability than the third portion 44. In some implementations, the system 200 utilizes a generative model to generate the complex version 44a of the third portion 44. The generative model accepts the third portion 44 as an input and outputs the complex version 44a as an output. In some implementations, the complex version 44a of the third portion 44 includes more textual content than the third portion 44. In various implementations, the complex version 44a has a greater lexical complexity than the third portion 44. For example, in some implementations, the complex version 44a utilizes longer sentences (e.g., run-on sentences) that are more difficult to understand than shorter sentences used in the third portion 44. In some implementations, the complex version 44a replaces simpler words with more challenging words. In some implementations, the system 200 utilizes a thesaurus to replace some of the words in the third portion 44 with longer words or words that are less utilized in common literature in order to make the complex portion 44a more challenging for the user 12.

Referring to FIGS. 1Q and 1R, in some implementations, the system 200 generates a question based on a gaze of the user 12. In the example of FIG. 1Q, the device 20 detects that a gaze 100 of the user 12 is directed to the word “esteemed” for a gaze duration 102 that is greater than a time threshold 104. Referring to FIG. 1R, in response to detecting that the user 12 gazed at the word “esteemed” for longer than the time threshold 104, the device 20 generates a question 106 asking what the word “esteemed” means. More generally, in various implementations, when the device 20 detects that a gaze of the user 12 is focused on (e.g., dwells on) a portion of the displayed content for a certain amount of time, the system 200 determines that the user 12 may be having difficulty in comprehending that portion of the displayed content. As such, the system 200 generates a question to test the user's understanding of that portion of the displayed content.

Referring to FIGS. 1S and 1T, in some implementations, the system 200 generates a question based on a fluency of the user 12. In the example of FIG. 1S, the device 20 detects an utterance 110 that corresponds to the phrase “sustenance and prosperity” indicated by a focus indicator 112. The device 20 determines a fluency score 114 that indicates a fluency with which the user 12 spoke the phrase “sustenance and prosperity”. The system 200 determines that the fluency score 114 is less than a fluency threshold 116. Referring to FIG. 1T, in response to detecting that the fluency score 114 is less than the fluency threshold 116, the system 200 generates a question 118 asking what the cat promised to her master. More generally, in various implementations, when the system 200 detects that a fluency score associated with a portion of the displayed content is less than the fluency threshold 116, the system 200 determines that the user 12 may be having difficulty in comprehending that portion of the displayed content. As such, the system 200 generates a question to test the user's understanding of that portion of the displayed content.

Referring to FIG. 1U, in some implementations, the device 20 displays a set of questions related to displayed content after a timer 120 expires. In the example of FIG. 1U, a time duration of the timer 120 is 30 seconds. As such, the system 200 displays the first portion 40 for a time duration of 30 seconds and the system 200 displays the questions 62 (shown in FIG. 1F) after displaying the first portion 40 for the time duration of 30 seconds.

Referring to FIG. 1V, in some implementations, the system 200 generates a set of questions 62′ based further on a user characteristic 130. In some implementations, the user characteristic 130 indicates a language preference 132. In the example of FIG. 1V, the language preference 132 includes a primary language (English) and a secondary language (Spanish). In some implementations, the system 200 utilizes a multilingual model to generate questions in multiple languages. In the example of FIG. 1V, a first question 62a is in the secondary language and a remainder of the questions 62 are in the primary language. In some implementations, the question in the secondary language is associated with a lower difficulty level than the questions in the primary language. In the example of FIG. 1V, the first question 62a is relatively easy while the remaining questions are more difficult.

In some implementations, the user characteristic 130 indicates an age 134 of the user 12. In such implementations, the system 200 generates the questions 62′ based further on the age 134 of the user 12 so that the questions 62′ are age-appropriate. In some implementations, the user characteristic 130 indicates a reading level 136 of the user 12. The reading level 136 may be associated with a reading level scale such as the Flesch-Kincaid grade level that provides a U.S. school grade level as an indication of the reading difficulty that the user 12 may be comfortable with. For example, the reading level 136 having a value of 8.0 refers to the user 12 being able to read at the same level as an eighth grader. In such implementations, the system 200 generates the questions 62′ such that the questions 62′ test the comprehension of a person at the reading level 136.

Referring to FIG. 1W, in some implementations, the system 200 utilizes a multi-modal model to generate generative content. As such, in some implementations, the generative content includes a combination of textual content, images, video, vector graphics, etc. In the example of FIG. 1W, the system 200 generates graphical content 140 in order to assist the user 12 in comprehending content. In the example of FIG. 1W, the device 20 displays the graphical content 140 in addition to the simplified version 40a of the first portion 40. Alternatively, in some implementations, the device 20 displays the graphical content 140 instead of the simplified version 40a. For example, the device 20 may display the graphical content 140 without displaying textual content. As another example, the device 20 may display the graphical content 140 while displaying the first portion 40 of the media content item 32a. In the example of FIG. 1W, the graphical content 140 includes a mill adjacent to the oldest son indicating that the oldest son received the mill, a donkey adjacent to the second son indicating that the second son received the donkey, and a cat adjacent to the youngest son to indicate that the youngest son received the cat.

Referring to FIG. 1X, in some implementations, the system 200 generates and displays an animation 150 in response to the reading comprehension value 50 satisfying a threshold. In the example of FIG. 1X, the third reading comprehension value 54c is greater than an upper end of the acceptable reading comprehension score range 82. Since the user 12 correctly answered all the questions 88, the system 200 displays the animation 150 of a cat 152 jumping on a table 154. In various implementations, the system 200 generates the animation 150 based on the textual content that the user 12 finished answering questions regarding. In the example of FIG. 1X, the user 12 finished answering the questions 88 related to the second portion 42 of the first media content item 32a which ends with Puss jumping on the table.

FIGS. 1Y-1AA illustrates a sequence in which the user 12 requests for insights into the content that the user 12 is viewing. FIG. 1Y illustrates an information icon 160 that the user 12 can select in order to get additional information regarding the first media content item 32a. In FIG. 1Z, the device 20 detects a user input 162 selecting the information icon 160. In response to the user input 162 selecting the information icon 160, the device 20 displays a menu 164 shown in FIG. 1AA.

In various implementations, the menu 164 includes a story re-cap button 164a, a character re-cap button 164b, a character location button 164c and a context button 164d. In some implementations, a user selection of the story re-cap button 164a triggers the system 200 to generate a summary of a portion of the first media content item 32a that the user 12 has viewed so far. The summary is tailored to the user 12 based on the reading comprehension score 50 of the user 12. As such, different users may be presented with a different summary based on their respective reading comprehension scores. In some implementations, the summary is based on a viewing history of the user 12. For example, if the user 12 viewed previous portions of first media content item 32a over a relatively long time duration (e.g., over a span of weeks), the summary may include more details in order to assist the user 12 with memory recall. By contrast, if the user 12 viewed previous portions of the first media content item 32a over a relatively short time duration (e.g., within the last one or two days), the summary may include fewer details because the user 12 is more likely to remember a plot associated with the first media content item 32a.

In some implementations, a user selection of the character re-cap button 164b triggers the system 200 to generate a summary of a character (e.g., a lead character or all the characters) depicted in the content of the first media content item 32a. In some implementations, the summary of the character indicates previous actions of the character, goals of the character, relationships of the character, etc.

In some implementations, a user selection of the character location button 164c triggers the system 200 to indicate respective locations of various characters depicted within the first media content item 32a. In some implementations, the system 200 generates a map of a geographical space depicted in the first media content item 32a, and indicates the respective locations of the characters on the map.

In some implementations, a user selection of the context button 164d triggers the system 200 to provide contextual information regarding the content. In some implementations, the system 200 generates the contextual information by extrapolating information included in the content. As such, in some implementations, the contextual information includes new information that is not included in the content. As an example, the contextual information may state that the old man had a will, and the old man bequeathed his assets in the will.

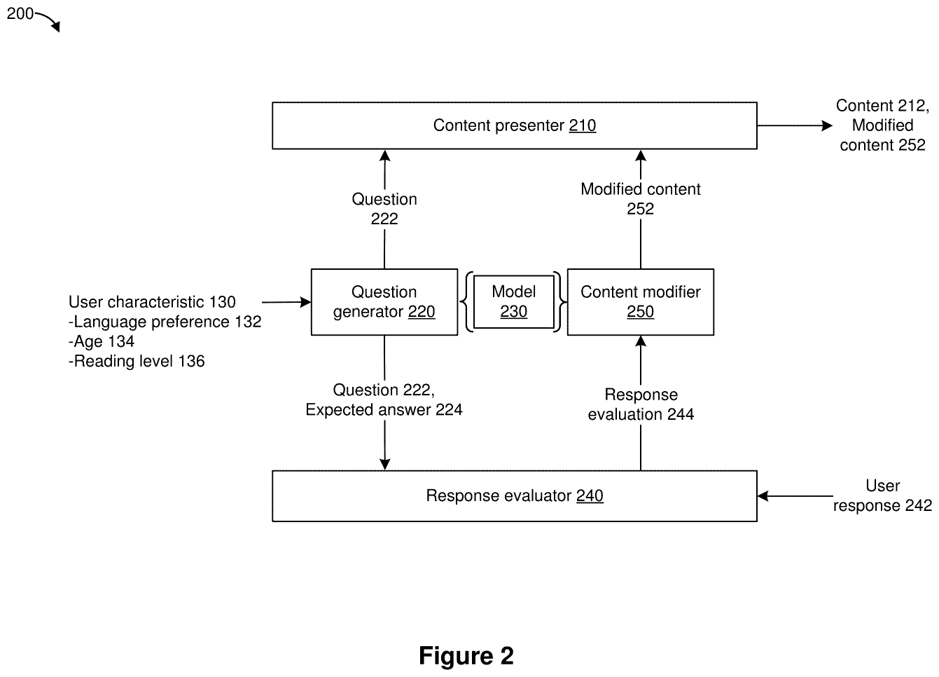

FIG. 2 is a block diagram of the system 200 in accordance with some implementations. In some implementations, the system 200 includes a content presenter 210, a question generator 220, a response evaluator 240 and a content modifier 250. In some implementations, the system 200 includes a set of one or more models 230 (“model 230”, hereinafter for the sake of brevity) that implements the question generator 220 and/or the content modifier 250.

In various implementations, the content presenter 210 presents content 212. For example, as shown in FIG. 1D, the content presenter 210 presents the first portion 40 of the first media content item 32a. In some implementations, the content 212 includes textual content (e.g., a portion of an e-book, a research paper, a magazine article, a webpage, etc.). In some implementations, the content 212 includes audio content (e.g., an audio book, a podcast, etc.). In some implementations, the content 212 includes video content (e.g., a lecture, a presentation, a movie or a TV show). In various implementations, the content 212 is associated with multiple modalities (e.g., the content 212 includes a combination of textual content, images and audio).

In some implementations, the content 212 includes authored content. For example, the content 212 is created by a human author and not a machine. In some implementations, the content 212 is referred to as human-generated content that is created by a human. Human-generated content is different from machine-generated content that is generated by a machine without human input.

In various implementations, the question generator 220 generates a question 222 that relates to the content 212 being presented. For example, the question generator 220 generates the questions 62 shown in FIG. 1F. The question generator 220 provides the question 222 to the content presenter 210, and the content presenter 210 displays the question 222 on a display for the user to answer. In some implementations, the question generator 220 provides the question 222 and an expected answer 224 for the question 222 to the response evaluator 240.

In some implementations, the question generator 220 includes the model 230, and the model 230 generates the question 222. In some implementations, the model 230 includes a generative model such as a Large Language Model (LLM) that generates the question 222. The model 230 accepts the content 212 as an input and provides the question 222 as an output.

In some implementations, the question generator 220 generates the question 222 based further on the user characteristic 130 of a user viewing the content 212. For example, the question generator 220 generates the question 222 based on the language preference 132 of the user. In some implementations, the question 222 is in a language indicated by the language preference 132. In some implementations, the question 222 includes a first set of questions in a first language indicated as a primary language and a second set of questions in a second language indicated as a secondary language (e.g., the first question 62a shown in FIG. 1V is in Spanish and the remaining questions 62′ are in English).

In some implementations, the question generator 220 determines a difficulty of the question 222 based on the user characteristic 130. For example, questions in the primary language may be more difficult to answer than questions in the secondary language. As another example, the difficulty of the question 222 may be based on the age 134 of the user. For example, the question generator 220 may generate a relatively easy question when the age 134 of the user is less than a threshold, and a relatively difficult question when the age 134 of the user is greater than the threshold. In some implementations, the question generator 220 generates the question 222 based on the reading level 136 of the user. For example, the difficulty of the question 222 may be based on the reading level 136 of the user.

In some implementations, the response evaluator 240 receives a user response 242 after the content presenter 210 displays the question 222. The response evaluator 240 evaluates the user response 242 by comparing the user response 242 with the expected answer 224. The response evaluator 240 provides a response evaluation 244 to the content modifier 250.

The content modifier 250 determines whether to modify the content 212 based on the response evaluation 244. In some implementations, the response evaluation 244 indicates a reading comprehension level of the user. For example, the response evaluation 244 may include the first reading comprehension value 54a shown in FIG. 1H. In some implementations, the content modifier 250 generates modified content 252 when the reading comprehension level does not match a reading level of the content 212. The content modifier 250 provides the modified content 252 to the content presenter 210, and the content presenter 210 displays the modified content 252 on a display.

In some implementations, the content modifier 250 includes the model 230 that generates the modified content 252. In some implementations, the model 230 includes a generative model such as an LLM. In some implementations, the model 230 accepts the content 212 and the response evaluation 244 as inputs, and outputs the modified content 252. In some implementations, the content modifier 250 determines a degree of modification to the content 212 based on a difference between the user response 242 and the expected answer 224. For example, if the response evaluation 244 indicates that the user answered 20% of the questions incorrectly, the content modifier 250 modifies the content 212 to reduce a comprehension difficulty by 20%. As another example, if the response evaluation 244 indicates that the user answered 50% of the questions incorrectly, the content modifier 250 modifies the content 212 to reduce the comprehension difficulty by 50%. As another example, answering a first number of questions incorrectly (e.g., 20%) reduces a grade level of the content 212 by a first number of grades (e.g., one grade), and answering a second number of questions incorrectly (e.g., 40%) reduces the grade level of the content 212 by a second number of grades (e.g., two grades) In some implementations, the content 212 is associated with a first grade level. For example, the content 212 may be suitable for an eighth grader. In some implementations, the response evaluation 244 indicates that the user has a reading comprehension level corresponding to a second grade level that is different from the first grade level. For example, the response evaluation 244 may indicate that the user has the same reading comprehension abilities as a fifth grader. In some implementations, the content modifier 250 determines whether the first grade level associated with the content 212 matches the second grade level indicated by the response evaluation 244. In some implementations, the content modifier 250 determines to modify the content 212 when a difference between the first grade level and the second grade level is greater than a threshold. For example, if the content 212 is for an eighth grader and the response evaluation 244 indicates that the user is reading at a level of a fifth grader, the content modifier 250 modifies the content 212 so that the modified content 252 is at the level of the fifth grader. In some implementations, the content modifier 250 determines to forgo modifying the content 212 when the difference between the first grade level and the second grade level is less than the threshold. For example, if the content 212 is for an eighth grader and the response evaluation 244 indicates that the user is reading at a level of a ninth grader, the content modifier 250 determines to forgo modifying the content 212.

In some implementations, the content modifier 250 makes the content 212 easier to comprehend when the response evaluation 244 indicates that the user response 242 does not match the expected answer 224. In some implementations, the modified content 252 is shorter than the content 212. In some implementations, the modified content 252 uses shorter sentences and/or shorter words than the content 212 in order to make the modified content 252 easier to comprehend than the content 212. In some implementations, the content modifier 250 reduces a number of characters depicted in the content 212. For example, the modified content 252 may include fewer supporting characters than the content 212. In some implementations, the content modifier 250 simplifies a relationship between two characters in order to make the relationship easier to understand. For example, the content modifier 250 may change a relationship from wife's second cousin's spouse to a distant relative. In some implementations, the content modifier 250 simplifies an underlying plot of the content 212 (e.g., by reducing a number of subplots, for example, by replacing a current plot template with a simpler plot template).

In some implementations, the content modifier 250 makes the content 212 more challenging to comprehend when the response evaluation 244 indicates that the user response 242 matches the expected answer 224 (e.g., when the user answers all questions correctly). In some implementations, the modified content 252 is longer than the content 212. In some implementations, the modified content 252 uses longer sentences and/or longer words than the content 212 in order to make the modified content 252 more challenging to comprehend than the content 212. In some implementations, the content modifier 250 increases a number of characters depicted in the content 212. For example, the modified content 252 may include additional supporting characters than the content 212. In some implementations, the content modifier 250 complicates a relationship between two characters in order to make the relationship more challenging to understand. For example, the content modifier 250 may change a relationship from a distant relative to wife's second cousin's spouse. In some implementations, the content modifier 250 increases a complexity of an underlying plot of the content 212 (e.g., by increasing a number of subplots, for example, by replacing a current plot template with a more complex plot template).

In some implementations, a difference between the modified content 252 and the content 212 satisfies a modification threshold. In some implementations, the content 212 is associated with a constitution or a manifest that specifies certain definitive acts. In such implementations, the modified content 252 includes the definitive acts specified by the constitution or the manifest. As such, the content modifier 250 modifies the content 212 to a limited degree such that the modified content 252 still conforms to the constitution or the manifest associated with the content 212.

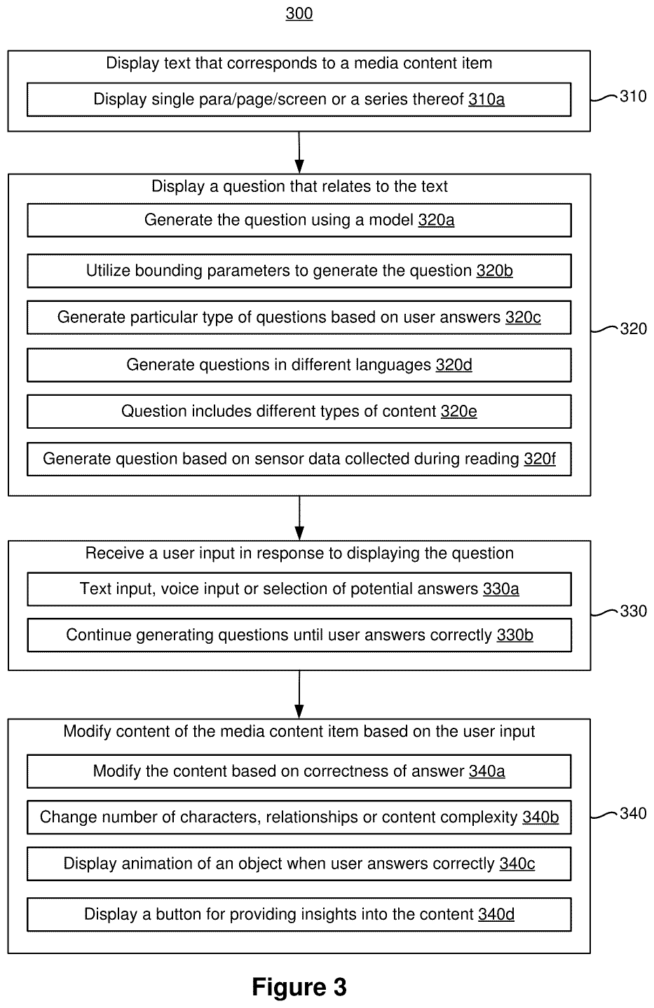

FIG. 3 is a flowchart representation of a method 300 for dynamically modifying content. In various implementations, the method 300 is performed by a device including a display, a non-transitory memory and one or more processors coupled with the display and the non-transitory memory (e.g., the device 20 shown in FIGS. 1A-1AA and/or the system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes displaying, on the display, text that corresponds to a portion of a media content item. For example, as shown in FIG. 1D, the device 20 displays the first portion 40 of the first media content item 32a. In some implementations, the device displays a selectable GUI element representing the media content item, and the device displays the portion of the media content item after detecting a user input selecting the selectable GUI element (e.g., as shown in FIGS. 1A and 1B).

As represented by block 310a, in some implementations, displaying the text includes displaying a set of one or more pages, a set of one or more paragraphs or a set of one or more sentences from a book. For example, as shown in FIG. 1D, the device 20 displays the first portion 40 that corresponds to the first paragraph. In some implementations, displaying the text includes displaying a series of screens that corresponds to a section of a book. For example, the device displays a sequence of pages that corresponds to a chapter of the book before testing the user's comprehension of the chapter.

As represented by block 320, in some implementations, the method 300 includes after displaying the text on the display, displaying, on the display, a question that relates to the text in order to determine whether a user of the device is comprehending the text. For example, as shown in FIG. 1F, the device 20 displays the questions 62 that relate to the first portion 40 of the first media content 32a displayed in FIGS. 1D and 1E.

As represented by block 320a, in some implementations, the method 300 includes generating the question based on a semantic analysis of the text. For example, referring to FIGS. 1E and 1F, the device 20 and/or the system 200 generate the questions 62 based on a semantic analysis of the first portion 40 of the first media content item 32a. In some implementations, the method 300 includes utilizing a model to generate the question. In some implementations, the model includes a generative model such as a large language model (LLM). For example, referring to FIG. 2, the question generator 220 utilizes the model 230 to generate the question 222. In some implementations, the method 300 includes training the model with books and questions associated with the books. For example, referring to FIG. 2, the system 200 trains the model 230 using training data that includes human-curated content, and corresponding human-curated questions and answers.

As represented by block 320b, in some implementations, the model is associated with bounding parameters that limit the model to generate questions that relate to topics that are associated with the media content item. As such, the questions generated by the model are relevant to the content that the user views. In some implementations, the model adheres to a manifest that lists whitelisted topics and/or blacklisted topics. In such implementations, the model generates questions that test the user's comprehension of the content and are related to the whitelisted topics while avoiding questions related to the blacklisted topics. In some implementations, a person (e.g., the user, a teacher, a parent or a guardian of the user) specifies the whitelisted topics and/or the blacklisted topics. In some implementations, the device generates the list of whitelisted topics and/or blacklisted topics based on the user's historical reading comprehension scores.

As represented by block 320c, in some implementations, the method 300 includes adapting the model to generate a particular type of questions based on user responses to previously generated questions. For example, the device biases the model to generate more emotional questions (e.g., how is the character feeling?) than factual questions if the user tends to answer emotional questions incorrectly and factual questions correctly. In some implementations, the device adapts the model by automatically modifying the whitelisted topics and/or the blacklisted topics. For example, if the user has historically answered factual questions correctly but emotional questions incorrectly (e.g., how does the character feel?), then the device can bias the model to generate emotional questions by putting factual topics among the blacklisted topics and placing emotional topics among the whitelisted topics in order to improve the user's ability to comprehend emotional topics related to the content.

As represented by block 320d, in some implementations, the model is a multilingual model that is trained to generate questions in multiple languages. As an example, referring to FIG. 2, the model 230 may be a multilingual model. In some implementations, the model is trained to generate questions with different levels of difficulty for different languages. For example, the model may be trained to generate relatively simple questions in a first language (e.g., a primary language of the user) and relatively complex questions in a second language (e.g., a secondary language of the user). As an example, referring to FIG. 1V, the first question 62a is in Spanish and a remainder of the questions 62′ are in English. Generating questions in different languages helps in testing the user's reading comprehension skills in multiple languages.

As represented by block 320e, in some implementations, the model is a multi-modal model that generates questions that invoke different sensory modalities (e.g., visual, auditory and/or tactile). In some implementations, the questions include a combination of text, images, video and vectorized graphics. As an example, a question may present multiple images and prompt the user to select one of the images that most accurately represents what the text says. As another example, a question may present multiple videos and prompt the user to select one of the videos that most accurately represents a summary of the content.

As represented by block 320f, in some implementations, the method 300 includes obtaining sensor data that indicates a speaking fluency of the user while the user is reading the text aloud, and generating the question based on a portion of the text that is associated with reduced fluency. For example, as illustrated in FIGS. 1S and 1T, the system 200 generates the question 118 to test the user's comprehension of a phrase that the user 12 was unable to speak with sufficient fluency. As such, when the user slows down to read a portion of the text, the device generates a question to test the user's comprehension of that portion of the text.

In some implementations, the method 300 includes obtaining sensor data that indicates a gaze position and a gaze duration while the user is reading the text, and generating the question based on a portion of the text that the user gazed at for more than a threshold amount of time. For example, as illustrated in FIGS. 1Q and 1R, the system 200 generates the question 106 to test the user's comprehension of a word that the user 12 gazed at for a relatively long time duration. As such, when the user gazes at a portion of the text for longer than a threshold time, the device generates a question to test the user's comprehension of that portion of the text.

In some implementations, the method 300 includes determining the question based on a characteristic of the user. For example, as shown in FIG. 2, the question generator 220 generates the question 222 based on the user characteristic 130. As discussed in relation to FIG. 2, the characteristic of the user may include the language preference 132 of the user, the age 134 of the user, and/or the reading level 136 of the user. In some implementations, the characteristic of the user includes historical reading comprehension scores of the user. In some implementations, the characteristic of the user indicates a similarity between the media content item that the user is currently reading and previous media content items that the user has read.

In some implementations, the method 300 includes selecting the question from a set of pre-generated questions. In some implementations, the pre-generated questions are human-curated questions, and the device selects a subset of the pre-generated questions that is most relevant to the portion of the text that the user finished reading. For example, an author of a textbook may provide questions for a chapter, and the device selects questions related to a particular subchapter after determining that the user has finished reading the subchapter.

In some implementations, displaying the question includes displaying the question after the text has been displayed for a predetermined amount of time. For example, as shown in FIG. 1U, the system 200 displays a set of questions testing the user's comprehension of the first portion 40 after the timer 120 expires.

In some implementations, displaying the question includes displaying the question after determining that the user has read the text. In some implementations, the device determines that the user has read the text based on a voice input that corresponds to the user reading the text aloud. In some implementations, the device determines that the user read the text by tracking a gaze of the user, and determining that the gaze has passed over an entirety of the text.

As represented by block 330, in some implementations, the method 300 includes receiving a user input in response to displaying the question. In some implementations, the user input corresponds to a user-specified answer to the question. As represented by block 330a, in some implementations, receiving the user input includes detecting a text input. For example, the device displays a text box that accepts a text string and the device detects the user typing a response to the question in the text box. In some implementations, receiving the user input includes detecting a voice input. For example, the device detects, via a microphone, an audio input that corresponds to a user's answer to the question. In some implementations, receiving the user input includes displaying a plurality of answer choices and detecting a user selection of one of the plurality of answer choices. For example, as shown in FIG. 1G, the user 12 has answered the questions 62 by selecting the appropriate radio buttons.

As represented by block 330b, in some implementations, the method 300 includes generating subsequent questions until the user starts answering questions in a consistent manner. In some implementations, the device generates a reading comprehension score value that indicates a reading comprehension level of the user and a confidence value that indicates a reliability of the reading comprehension score value. If the user is inconsistent in answering similar questions (e.g., the user answers a question related to a fact correctly but answers another question related to the same fact incorrectly), the confidence value may be unacceptably low (e.g., below a threshold, for example, below 0.5). As such, in some implementations, the device continues generating questions until the user answers the questions in a consistent manner. In some implementations, the device continues generating questions until the device is able to generate a reading comprehension score value that is associated with a confidence value that is greater than the threshold (e.g., greater than 0.5). Asking additional questions until the user starts answering the questions in a consistent manner tends to improve a reliability of the reading comprehension score value.

As represented by block 340, in some implementations, the method 300 includes modifying content of the media content item based on an evaluation of the user input. For example, as shown in FIG. 2, the content modifier 250 generates the modified content 252 based on the response evaluation 244 of the user response 242. In some implementations, the device utilizes a model (e.g., a generative model such as an LLM) to generate a modified version of the content. For example, the system 200 utilizes the model 230 shown in FIG. 2.

In various implementations, modifying the content of the media content item assists the user in better comprehending the content of the media content item thereby enhancing a user experience provided by the device. In some implementations, modifying the content allows the user to consume the content (e.g., read the text) in a shorter amount of time thereby reducing a power consumption of the device by decreasing an amount of time that the display is kept on. In some implementations, modifying the content reduces a number of user inputs that correspond to the user performing searches on a search engine in order to comprehend the content thereby reducing resource utilization associated with detecting, interpreting and responding to unnecessary the user inputs. More generally, in various implementations, modifying the content improves a functionality of the device by increasing a relevance of the displayed content, reducing power consumption associated with prolonged display usage, and reducing resource utilization associated with unnecessary search inputs.

As represented by block 340a, in some implementations, modifying the content of the media content item includes modifying the content of the media content item in a first manner when the evaluation indicates that the user answered the question correctly, and modifying the content of the media content item in a second manner when the evaluation indicates that the user answered the question incorrectly. In some implementations, the device generates a simplified version of the content that is easier to understand when the evaluation indicates that the user has answered a threshold number of questions incorrectly. For example, as shown in FIGS. 1I and 1J, the system 200 generates the simplified version 40a of the first portion 40 in response to the first reading comprehension value 54a being below a lower end of the acceptable reading comprehension score range 82. By contrast, in some implementations, the device generates a complex version of the content that is more difficult to understand when the evaluation indicates that the user has answered the threshold number of questions correctly. For example, as shown in FIGS. 1O and 1P, the system 200 generates the complex version 44a of the third portion 44 in response to the third reading comprehension value 54c being greater than an upper end of the acceptable reading comprehension value 82.

In some implementations, modifying the content of the media content item includes increasing a complexity of a second portion of the media content item when the user answers the question correctly, and decreasing the complexity of the second portion when the user answers the question incorrectly. In some implementations, the device increases a complexity of a subsequent portion of the media content item when the user answers all questions related to a current portion correctly. For example, as shown in FIGS. 1M-1P, the device 20 displays a complex version 44a of the third portion 44 after the user 12 answers the questions 88 related to the second portion 42 correctly. In some implementations, the device decreases the complexity of the subsequent portion of the media content item when the user answers a threshold number of questions related to the current portion incorrectly.

In some implementations, the device modifies the content of the media content item by adjusting a lexical complexity of the text. In some implementations, the device adjusts the lexical complexity of the text by changing a lexical diversity of the text. For example, the device increases a lexical diversity of the text by using more unique words with few repetitions. In some implementations, the device adjusts the lexical complexity of the text by changing a lexical density of the text. For example, the device adjusts a proportion of content words (e.g., nouns, verbs, adjectives and adverbs) relative to function words (e.g., prepositions, conjunctions and articles). In some examples, the device increases a lexical density of the text by including more content words and reducing function words. In some implementations, the device adjusts the lexical complexity of the text by changing a lexical sophistication of the text. For example, the device an increase a lexical complexity of the text by using vocabulary that is less frequent and more challenging for the user. In some implementations, the device adjusts the lexical complexity of the text by adjusting a lexical variation of the text, for example, by changing a variety of word forms and structures used in the text (e.g., by reducing synonyms and different grammatical forms to reduce the lexical variation).

As represented by block 340b, in some implementations, modifying the content of the media content item includes changing a number of entities (e.g., characters) depicted in the media content item. In some implementations, the method 300 includes reducing characters when the evaluation indicates a comprehension score that is below a threshold. In some implementations, the device modifies the content by changing an amount of text dedicated to each character. For example, the device can increase the complexity of the content by dedicating additional text to supporting characters. By contrast, the device can remove or reduce references to supporting characters in subsequent portions of the media content item in order to reduce the complexity of the text.

In some implementations, modifying the content of the media content item includes changing a relationship between characters depicted in the media content item. For example, the method 300 includes simplifying the relationship when the evaluation indicates a reading comprehension score that is below a threshold. As an example, the authored content specifies a relationship between a king and his advisor as the king's advisor plotting to overthrow the king with the help of the neighboring kingdom. In this example, the device simplifies the relationship to the king's advisor secretly trying to become the king.

In some implementations, modifying the content of the media content item includes changing a plot template of the media content item. For example, the device switches from a plot template with multiple subplots to a plot template with a straightforward adventure with a clear beginning, middle and end. As another example, the device switches a plot template from a suspense plot template with numerous surprises and plot twists to a simpler plot template with a more straightforward storyline. More generally, in various implementations, the device modifies a plot associated with the media content item. For example, the device can remove or reduce a number of subplots in order to assist the user in comprehending the text. By contrast, the device can introduce additional subplots in order to challenge the user's reading comprehension abilities.

In some implementations, modifying the content includes utilizing a multi-modal model that generates a combination of images, vectorized graphics, captions for images in the media content item, images for headings or subheadings in the media content item and scene descriptions of scenes depicted in the media content item. More generally, the multi-modal model generates content associated with multiple modalities (e.g., multiple senses). For example, the multi-modal model may generate visual content that the user can see with his/her eyes, auditory content that the user can hear with his/her ears and haptic content that the user can feel through touch. Within visual content, the multi-modal model may generate different types of visual content. For example, the multi-modal model can generate textual content, images, vectorized graphics including webpages. As an example, referring to FIG. 1W, the system 200 generates the graphical content 140 in addition to generating the simplified version 40a of the first portion 40. Generating content in multiple modalities assists the user in comprehending content, for example, because the user may find it easier to understand the content by looking at images, viewing videos or listening to audio instead of reading text.

As represented by block 340c, in some implementations, modifying the content of the media content item comprises displaying an animation of an object depicted in the media content item when the evaluation indicates that the user answered the question correctly. For example, as shown in FIG. 1X, the device 20 displays the animation 150 of the cat 152 jumping on the table 154. As another example, if the book shows a treasure box, the device displays an animation of the treasure box opening when the user answers the question correctly.

As represented by block 340d, in some implementations, the method 300 includes displaying a button that, when pressed, causes the device to present a summary of a particular character described in the text. For example, as shown in FIG. 1AA, the device 20 displays the character re-cap button 164b that, when pressed, triggers the system 200 to re-cap actions of a character depicted in a portion of the story that the user 12 has finished reading.

In some implementations, the method 300 includes displaying a button that, when pressed, causes the device to display respective locations of characters described in the media content item. For example, as shown in FIG. 1AA, the device 20 displays the character location button 164c that, when pressed, displays respective locations of characters depicted in the story on a map that corresponds to a fictional environment described in the story.

In some implementations, the method 300 includes displaying a button that, when pressed, causes the device to present a summary of the text. For example, as shown in FIG. 1AA, the device 20 displays the story re-cap button 164a that, when pressed, triggers the system 200 to generate and present a re-cap of a portion of the story that the user 12 has finished reading.

In some implementations, the method 300 includes displaying a button that, when pressed, causes the device to provide additional details regarding a scene described in the text. For example, as shown in FIG. 1AA, the device 20 displays the context button 164d that, when pressed, triggers the system 200 to generate and present additional context regarding the story.

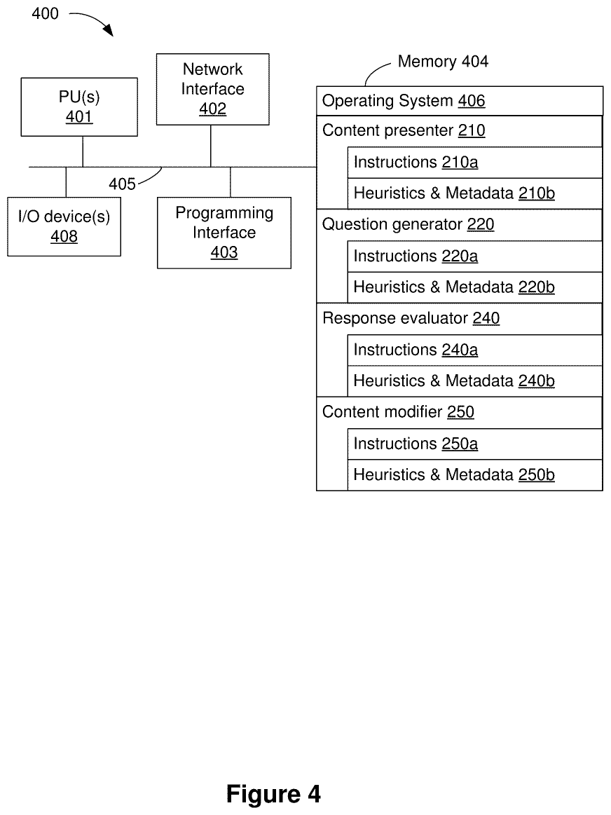

FIG. 4 is a block diagram of a device 400 in accordance with some implementations. In some implementations, the device 400 implements the device 20 shown in FIGS. 1A-1AA and/or the system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the content presenter 210, the question generator 220, the response evaluator 240 and the content modifier 250. In various implementations, the device 400 performs the method 300 shown in FIG. 3.

In some implementations, the content presenter 210 includes instructions 210a, and heuristics and metadata 210b for presenting content (e.g., the content 212 and/or the modified content 252 shown in FIG. 2). In some implementations, the content presenter 210 performs at least some of the operation(s) represented by blocks 310 and 320 in FIG. 3.

In some implementations, the question generator 220 includes instructions 220a, and heuristics and metadata 220b for generating questions (e.g., the questions 62 shown in FIG. 1F). In some implementations, the question generator 220 performs at least some of the operation(s) represented by block 320 in FIG. 3.

In some implementations, the response evaluator 240 includes instructions 240a, and heuristics and metadata 240b for evaluating user-specified responses to questions (e.g., for generating the response evaluation 244 shown in FIG. 2). In some implementations, the response evaluator 240 performs at least some of the operation(s) represented by block 330 in FIG. 3.

In some implementations, the content modifier 250 includes instructions 250a, and heuristics and metadata 250b for modifying content of a media content item (e.g., for generating the modified content 252 shown in FIG. 2). In some implementations, the content modifier 250 performs at least some of the operation(s) represented by block 340 in FIG. 3.

In some implementations, the one or more I/O devices 408 include an input device for obtaining an input (e.g., the user input 34 shown in FIG. 1B, the user input 60 shown in FIG. 1E, the user input 66 shown in FIG. 1G, etc.). In some implementations, the one or more I/O devices 408 include an environmental sensor for capturing environmental data. In some implementations, the one or more I/O devices 408 include one or more image sensors (e.g., for detecting the gaze 100 shown in FIG. 1Q). For example, the one or more I/O devices 408 may include a front-facing camera of a smartphone or a tablet for capturing images of the user's eyes. As another example, the one or more I/O devices 408 may include a user-facing camera of an HMD for capturing images of the user's eyes. In some implementations, the one or more I/O devices 408 include an audio sensor (e.g., a microphone) for capturing audio (e.g., for detecting the utterance 110 shown in FIG. 1S). In some implementations, the one or more I/O devices 408 include a display for displaying content (e.g., the content 212 and/or the modified content 252 shown in FIG. 2).

In various implementations, the one or more I/O devices 408 include a video pass-through display which displays at least a portion of a physical environment surrounding the device 400 as an image captured by a camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a display, non-transitory memory, and one or more processors:
displaying, on the display, text that corresponds to a portion of a media content item;
after displaying the text on the display, displaying, on the display, a question that relates to the text in order to determine whether a user of the device is comprehending the text;
receiving a user input in response to displaying the question; and
modifying content of the media content item based on an evaluation of the user input.

2. The method of claim 1, wherein modifying the content of the media content item comprises:
modifying the content of the media content item in a first manner when the evaluation indicates that the user answered the question correctly; and
modifying the content of the media content item in a second manner when the evaluation indicates that the user answered the question incorrectly.

3. The method of claim 1, wherein modifying the content of the media content item comprises:
increasing a complexity of a second portion of the media content item when the user answers the question correctly; and
decreasing the complexity of the second portion when the user answers the question incorrectly.

4. The method of claim 1, wherein modifying the content of the media content item comprises displaying an animation of an object depicted in the media content item when the evaluation indicates that the user answered the question correctly.

5. The method of claim 1, further comprising generating the question based on a semantic analysis of the text.

6. The method of claim 1, further comprising utilizing a model to generate the question.

7. The method of claim 6, further comprising training the model with books and questions associated with the books.

8. The method of claim 6, wherein the model is associated with bounding parameters that limit the model to generate questions that relate to topics that are associated with the media content item.

9. The method of claim 6, further comprising adapting the model to generate a particular type of questions based on user responses to previously generated questions.

10. The method of claim 6, wherein the model is a multi-modal model that generates a combination of images, vectorized graphics, captions for images in the media content item, images for headings or subheadings in the media content item and scene descriptions of scenes depicted in the media content item.

11. The method of claim 1, further comprising obtaining sensor data that indicates a speaking fluency of the user while reading the text aloud and generating the question based on a portion of the text that is associated with reduced fluency.

12. The method of claim 1, further comprising obtaining sensor data that indicates a gaze position and a gaze duration while the user is reading the text and generating the question based on a portion of the text that the user gazed at for more than a threshold amount of time.

13. The method of claim 1, wherein modifying the content of the media content item comprises changing a number of entities depicted in the media content item.

14. The method of claim 1, wherein modifying the content of the media content item comprises changing a relationship between characters depicted in the media content item.

15. A device comprising:
a display;
a non-transitory memory; and
one or more processors to:
display, on the display, text that corresponds to a portion of a media content item;
after displaying the text on the display, display, on the display, a question that relates to the text in order to determine whether a user of the device is comprehending the text;
receive a user input in response to displaying the question; and
modify content of the media content item based on an evaluation of the user input.

16. The method of claim 1, wherein the one or more processors are to modify the content of the media content item by:
increasing a complexity of a second portion of the media content item when the user answers the question correctly; and
decreasing the complexity of the second portion when the user answers the question incorrectly.

17. The method of claim 1, wherein the one or more processors are further to generate the question using a model trained with books and questions associated with the books.

18. The method of claim 1, wherein the one or more processors are to modify the content of the media content item by changing a number of entities depicted in the media content item.

19. The method of claim 1, wherein the one or more processors are to modify the content of the media content item by changing a relationship between characters depicted in the media content item.

20. A non-transitory memory storing one or more programs, which, when executed by one or more processors of a device including a display cause the device to
display, on the display, text that corresponds to a portion of a media content item;
after displaying the text on the display, display, on the display, a question that relates to the text in order to determine whether a user of the device is comprehending the text;
receive a user input in response to displaying the question; and
modify content of the media content item based on an evaluation of the user input.
